(19) United States
(12) Patent Application Publication
(10) Pub. No.: US 2020/0077253 A1
(43) Pub. Date: Mar. 5, 2020

(54) METHOD FOR TRANSMITTING AND RECEIVING DATA USING RELAY IN WIRELESS COMMUNICATION SYSTEM, AND APPARATUS THEREFOR

(71) Applicant: LG Electronics Inc., Seoul (KR)

(72) Inventors: Taehun KIM, Seoul (KR); Jaewook LEE, Seoul (KR)

(21) Appl. No.: 16/492,879

(22) PCT Filed: Mar. 12, 2018
(86) PCT No.: PCT/KR2018/002892

§ 371 Date: Sep. 10, 2019

Related U.S. Application Data
(60) Provisional application No. 62/485,397, filed on Apr. 14, 2017.
(60) Provisional application No. 62/483,976, filed on Apr. 11, 2017.
(60) Provisional application No. 62/469,519, filed on Mar. 10, 2017.
(60) Provisional application No. 62/469,518, filed on Mar. 10, 2017.

(51) Int. Cl. H04W 8/08; H04W 76/14; H04W 76/30

(52) U.S. Cl. CPC H04W 8/08; H04W 88/04; H04W 76/30; H04W 76/14

(57) ABSTRACT

The present invention relates to a method and an apparatus for a relay UE transmitting and receiving data between a base station and a remote UE in a wireless communication system. According to the present invention, a data transmission and reception method and apparatus may be provided, wherein the relay UE transmits a report message for reporting a connection state between the remote UE and the relay UE to a mobility management entity (MME) of the remote UE when the relay UE is in an IDLE mode, and receives a report acknowledgement message in response to the report message from the MME.

### TECHNICAL FIELD

The present invention relates to a wireless communication system, and more particularly, to a method for transmitting and receiving, by a remote user equipment) data to and from a network through a relay user equipment and an apparatus therefor.

### BACKGROUND ART

Mobile communication systems have been developed to provide voice services, while guaranteeing user activity. Service coverage of mobile communication systems, however, has extended even to data services, as well as voice services, and currently, an explosive increase in traffic has resulted in shortage of resource and user demand for a high speed services, requiring advanced mobile communication systems.

The requirements of the next-generation mobile communication system may include supporting huge data traffic, a remarkable increase in the transfer rate of each user, the accommodation of a significantly increased number of connection devices, very low end-to-end latency, and high energy efficiency. To this end, various techniques, such as small cell enhancement, dual connectivity, massive Multiple Input Multiple Output (MIMO), in-band full duplex, non-orthogonal multiple access (NOMA), supporting super-wide band, and device networking, have been researched.

### DISCLOSURE

### Technical Problem

An embodiment of the present invention provides a method for transmitting and receiving data to and from a network via a relay UE connected to a remote UE through PC5 (that is, air interface/reference point between UEs).

Furthermore, an embodiment of the present invention provides a method for transmitting generated downlink data to a remote UE through an indirect path of a relay UE when the downlink data for the remote UE are generated.

Furthermore, an embodiment of the present invention provides a method for a relay UE to report to a network whether a link is established with a remote UE in order for the network to transmit data of the remote UE through an indirect path.

Furthermore, an embodiment of the present invention provides a method for a relay UE to transmit a paging message to a remote UE when the remote UE is in an EMM-IDLE mode.

Furthermore, an embodiment of the present invention provides a method for a relay UE to receive a paging message for a remote UE at a paging occasion of the relay UE.

Objects of the present invention are not limited to the above-mentioned objects. That is, other objects that are not mentioned may be obviously understood by those skilled in the art to which the present invention pertains from the following description.

### Technical Solution

In this specification, a method for transmitting and receiving data between a base station and remote user equipment (remote UE) through a relay UE in a wireless communication system includes: transmitting, by the relay UE, a report message for informing a connection state between the remote UE and the relay UE in an IDLE mode to a mobility management entity (MME) of the remote UE; and receiving a report response message as a response to the report message from the MME.

Furthermore, in this specification, the method includes transmitting, by the relay UE, a report message for informing a connection state between the remote UE and the relay UE in an IDLE mode to a mobility management entity (MME) of the remote UE, and receiving a report response message as a response to the report message from the MME.

Furthermore, in this specification, the method further includes receiving a PC5 message including the report message and the S-TMSI or the GUMMEI from the remote UE.

Furthermore, in this specification, the method further includes: transmitting a request message requesting the S-TMSI or the GUMMEI to the remote UE; and receiving a response message including the S-TMSI or the GUMMEI from the remote UE.

Furthermore, in this specification, the report response message includes a local identifier of the remote UE which is allocated by the base station.

Furthermore, in this specification, the report message further includes an identity for identifying the remote UE and an indicator indicating the connection state or context information indicating the connection state of the remote UE.

Furthermore, in this specification, when the connection between the remote UE and the relay UE is released, the report message further includes an indicator indicating whether a state of the relay UE is in an out-of-coverage state.

Furthermore, in this specification, the method further includes: transmitting a message to inform the MME that the relay UE does not communication with the remote UE when the relay UE recognizes that the relay UE does not communication with the remote UE when receiving paging for the remote UE.

In this specification, a UE includes: a communication module configured to transmit and receive a wired/wireless signal; and a processor configured to control the communication module, in which the relay UE transmits a report message for informing a connection state between the remote UE and the relay UE in an IDLE mode to a mobility management entity (MME) of the remote UE and receives a report response message as a response to the report message from the MME.

### Advantageous Effects

The present invention has an advantage in that a network may recognize whether the link between the remote UE and the relay UE is established.

Furthermore, the present invention has an advantage in that data can be transmitted to the remote UE through the indirect path through the relay UE without additional signaling by recognizing whether the network establishes the link between the remote UE and the relay UE.

Furthermore, the present invention has an advantage in that the relay UE may reduce the power consumption of the relay UE by receiving the paging message for the remote UE at its own paging occasion instead of the paging occasion of the remote UE.

Effects which can be achieved by the present invention are not limited to the above-mentioned effects. That is, other objects that are not mentioned may be obviously understood by those skilled in the art to which the present invention pertains from the following description.

### DESCRIPTION OF DRAWINGS

In order to help understanding of the present invention, the accompanying drawings which are included as a part of the Detailed Description provide embodiments of the present invention and describe the technical features of the present invention together with the Detailed Description.

FIG. 1 is a diagram schematically illustrating an evolved packet system (EPS) to which the present invention may be applied.

FIG. 2 illustrates an example of a network structure of an evolved universal terrestrial radio access network (E-UTRAN) to which the present invention may be applied.

FIG. 3 illustrates structures of E-UTRAN and EPC in a wireless communication system to which the present invention may be applied.

FIG. 4 illustrates a radio interface protocol structure between a UE and the E-UTRAN in the wireless communication system to which the present invention may be applied.

FIG. 5 is a diagram schematically illustrating a structure of a physical channel in the wireless communication system to which the present invention may be applied.

FIG. 6 is a diagram for describing a contention based random access procedure in the wireless communication system to which the present invention may be applied.

FIG. 7 is a diagram illustrating a ProSe UE-to-Network Relay procedure in a wireless communication system to which the present invention can be applied.

FIG. 8 is a diagram illustrating a remote UE reporting procedure in the wireless communication system to which the present invention can be applied.

FIG. 9 is a diagram illustrating a remote UE information request procedure in the wireless communication system to which the present invention can be applied.

FIG. 10 is a diagram illustrating an SI release procedure in the wireless communication system to which the present invention can be applied.

FIG. 11 is a diagram illustrating a paging procedure in the wireless communication system to which the present invention can be applied.

FIG. 12 is a diagram illustrating an initial UE message procedure to which the present invention can be applied.

FIG. 13 is a diagram illustrating a remote UE report procedure according to an embodiment of the present invention.

FIG. 14 is a diagram illustrating a remote UE report procedure according to an embodiment of the present invention.

FIG. 15 is a diagram illustrating a message flow of a relay UE for a remote UE report procedure according to an embodiment of the present invention.

FIG. 16 is a diagram illustrating a remote UE report procedure according to an embodiment of the present invention.

FIG. 17 is a diagram illustrating a remote UE report procedure according to an embodiment of the present invention.

FIG. 18 is a diagram illustrating a paging procedure according to an embodiment of the present invention.

FIG. 19 is a diagram illustrating a paging procedure according to an embodiment of the present invention.

FIG. 20 is a block configuration diagram of a communication device according to an embodiment of the present invention.

FIG. 21 is a block configuration diagram of a communication device according to an embodiment of the present invention.

FIG. 22 is a diagram illustrating an example of an RF module of a wireless communication device to which a method proposed in this specification can be applied.

FIG. 23 is a diagram illustrating another example of an RF module of a wireless communication device to which a method proposed in this specification can be applied.

### MODE FOR INVENTION

In what follows, preferred embodiments according to the present invention will be described in detail with reference to appended drawings. The detailed descriptions provided below together with appended drawings are intended only to explain illustrative embodiments of the present invention, which should not be regarded as the sole embodiments of the present invention. The detailed descriptions below include specific information to provide complete understanding of the present invention. However, those skilled in the art will be able to comprehend that the present invention may be embodied without the specific information.

For some cases, to avoid obscuring the technical principles of the present invention, structures and devices well-known to the public may be omitted or may be illustrated in the form of block diagrams utilizing fundamental functions of the structures and the devices.

A base station in this document is regarded as a terminal node of a network, which performs communication directly with a UE. In this document, particular operations regarded to be performed by the base station may be performed by an upper node of the base station depending on situations. In other words, it is apparent that in a network consisting of a plurality of network nodes including a base station, various operations performed for communication with a UE may be performed by the base station or by network nodes other than the base station. The term Base Station (BS) may be replaced with a fixed station, Node B, evolved-NodeB (eNB), Base Transceiver System (BTS), or Access Point (AP). Also, a terminal may be fixed or mobile; and the term may be replaced with User Equipment (UE), Mobile Station (MS), User Terminal (UT), Mobile Subscriber Station (MSS), Subscriber Station (SS), Advanced Mobile Station (AMS), Wireless Terminal (WT), Machine-Type Communication (MTC) device, Machine-to-Machine (M2M) device, or Device-to-Device (D2D) device.

In what follows, downlink (DL) refers to communication from a base station to a terminal, while uplink (UL) refers to communication from a terminal to a base station. In downlink transmission, a transmitter may be part of the base station, and a receiver may be part of the terminal. Similarly, in uplink transmission, a transmitter may be part of the terminal, and a receiver may be part of the base station.

Specific terms used in the following descriptions are introduced to help understanding the present invention, and the specific terms may be used in different ways as long as it does not leave the technical scope of the present invention.

The technology described below may be used for various types of wireless access systems based on Code Division Multiple Access (CDMA), Frequency Division Multiple Access (FDMA), Time Division Multiple Access (TDMA), Orthogonal Frequency Division Multiple Access (OFDMA), Single Carrier Frequency Division Multiple Access (SC-FDMA), or Non-Orthogonal Multiple Access (NOMA). CDMA may be implemented by such radio technology as Universal Terrestrial Radio Access (UTRA) or CDMA2000. TDMA may be implemented by such radio technology as Global System for Mobile communications (GSM), General Packet Radio Service (GPRS), or Enhanced Data rates for GSM Evolution (EDGE). OFDMA may be implemented by such radio technology as the IEEE 802.11 (Wi-Fi), the IEEE 802.16 (WiMAX), the IEEE 802-20, or Evolved UTRA (E-UTRA). UTRA is part of the Universal Mobile Telecommunications System (UMTS). The 3rd Generation Partnership Project (3GPP) Long Term Evolution (LTE) is part of the Evolved UMTS (E-UMTS) which uses the E-UTRA, employing OFDMA for downlink and SC-FDMA for uplink transmission. The LTE-A (Advanced) is an evolved version of the 3GPP LTE system.

Embodiments of the present invention may be supported by standard documents disclosed in at least one of wireless access systems including the IEEE 802, 3GPP, and 3GPP2 specifications. In other words, among the embodiments of the present invention, those steps or parts omitted for the purpose of clearly describing technical principles of the present invention may be supported by the documents above. Also, all of the terms disclosed in this document may be explained with reference to the standard documents.

To clarify the descriptions, this document is based on the 3GPP LTE/LTE-A, but the technical features of the present invention are not limited to the current descriptions.

Terms used in this document are defined as follows.

Universal Mobile Telecommunication System (UMTS): the 3rd generation mobile communication technology based on GSM, developed by the 3GPP

Evolved Packet System (EPS): a network system comprising an Evolved Packet Core (EPC), a packet switched core network based on the Internet Protocol (IP) and an access network such as the LTE and UTRAN. The EPS is a network evolved from the UMTS.

NodeB: the base station of the UMTS network. NodeB is installed outside and provides coverage of a macro cell.

eNodeB: the base station of the EPS network. eNodeB is installed outside and provides coverage of a macro cell.

User Equipment (UE): A UE may be called a terminal, Mobile Equipment (ME), or Mobile Station (MS). A UE may be a portable device such as a notebook computer, mobile phone, Personal Digital Assistant (PDA), smart phone, or a multimedia device; or a fixed device such as a Personal Computer (PC) or vehicle-mounted device. The term UE may refer to an MTC terminal in the description related to MTC.

IP Multimedia Subsystem (IMS): a sub-system providing multimedia services based on the IP

International Mobile Subscriber Identity (IMSI): a globally unique subscriber identifier assigned in a mobile communication network

Machine Type Communication (MTC): communication performed by machines without human intervention. It may be called Machine-to-Machine (M2M) communication.

MTC terminal (MTC UE or MTC device): a terminal (for example, a vending machine, meter, and so on) equipped with a communication function operating through a mobile communication network(For example, communicating with an MTC server via a PLMN) and performing an MTC function

MTC server: a server on a network managing MTC terminals. It may be installed inside or outside a mobile communication network. It may provide an interface through which an MTC user may access the server. Also, an MTC server may provide MTC-related services to other servers (in the form of Services Capability Server (SCS)) or the MTC server itself may be an MTC Application Server.

(MTC) application: services (to which MTC is applied) (for example, remote metering, traffic movement tracking, weather observation sensors, and so on)

(MTC) Application Server: a server on a network in which (MTC) applications are performed

MTC feature: a function of a network to support MTC applications. For example, MTC monitoring is a feature intended to prepare for loss of a device in an MTC application such as remote metering, and low mobility is a feature intended for an MTC application with respect to an MTC terminal such as a vending machine.

MTC User (MTC User): The MTC user uses the service provided by the MTC server.

MTC subscriber: an entity having a connection relationship with a network operator and providing services to one or more MTC terminals.

MTC group: an MTC group shares at least one or more MTC features and denotes a group of MTC terminals belonging to MTC subscribers.

Services Capability Server (SCS): an entity being connected to the 3GPP network and used for communicating with an MTC InterWorking Function (MTC-IWF) on a Home PLMN (HPLMN) and an MTC terminal. The SCS provides the capability for use by one or more MTC applications.

External identifier: a globally unique identifier used by an external entity (for example, an SCS or an Application Server) of the 3GPP network to indicate (or identify) an MTC terminal (or a subscriber to which the MTC terminal belongs). An external identifier includes a domain identifier and a local identifier as described below.

Domain identifier: an identifier used for identifying a domain in the control region of a mobile communication network service provider. A service provider may use a separate domain identifier for each service to provide an access to a different service.

Local identifier: an identifier used for deriving or obtaining an International Mobile Subscriber Identity (IMSI). A local identifier should be unique within an application domain and is managed by a mobile communication network service provider.

Radio Access Network (RAN): a unit including a Node B, a Radio Network Controller (RNC) controlling the Node B, and an eNodeB in the 3GPP network. The RAN is defined at the terminal level and provides a connection to a core network.

Home Location Register (HLR)/Home Subscriber Server (HSS): a database provisioning subscriber information within the 3GPP network. An HSS may perform functions of configuration storage, identity management, user state storage, and so on.

RAN Application Part (RANAP): an interface between the RAN and a node in charge of controlling a core network (in other words, a Mobility Management Entity (MME)/Serving GPRS (General Packet Radio Service) Supporting Node (SGSN)/Mobile Switching Center (MSC)).

Public Land Mobile Network (PLMN): a network formed to provide mobile communication services to individuals. The PLMN may be formed separately for each operator.

Service Capability Exposure Function (SCEF): An entity within the 3GPP architecture for service capability exposure that provides a means for securely exposing services and capabilities provided by 3GPP network interfaces.

In what follows, the present invention will be described based on the terms defined above.

Overview of System to Which the Present Invention May be Applied

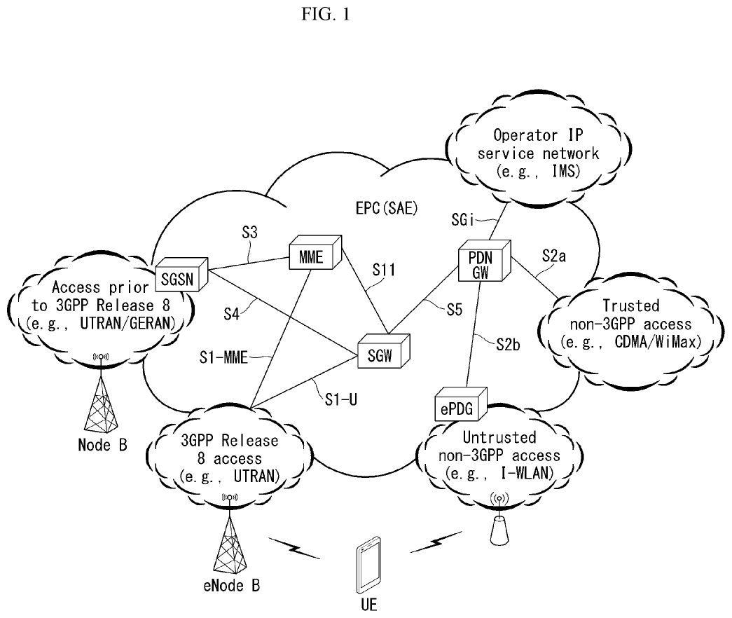

FIG. 1 illustrates an Evolved Packet System (EPS) to which the present invention may be applied.

The network structure of FIG. 1 is a simplified diagram restructured from an Evolved Packet System (EPS) including Evolved Packet Core (EPC).

The EPC is a main component of the System Architecture Evolution (SAE) intended for improving performance of the 3GPP technologies. SAE is a research project for determining a network structure supporting mobility between multiple heterogeneous networks. For example, SAE is intended to provide an optimized packet-based system which supports various IP-based wireless access technologies, provides much more improved data transmission capability, and so on.

More specifically, the EPC is the core network of an IP-based mobile communication system for the 3GPP LTE system and capable of supporting packet-based real-time and non-real time services. In the existing mobile communication systems (namely, in the 2nd or 3rd mobile communication system), functions of the core network have been implemented through two separate sub-domains: a Circuit-Switched (CS) sub-domain for voice and a Packet-Switched (PS) sub-domain for data. However, in the 3GPP LTE system, an evolution from the 3rd mobile communication system, the CS and PS sub-domains have been unified into a single IP domain. In other words, in the 3GPP LTE system, connection between UEs having IP capabilities may be established through an IP-based base station (for example, eNodeB), EPC, and application domain (for example, IMS). In other words, the EPC provides the architecture essential for implementing end-to-end IP services.

The EPC includes various components, where FIG. 1 illustrates part of the EPC components, including a Serving Gateway (SGW or S-GW), Packet Data Network Gateway (PDN GW or PGW or P-GW), Mobility Management Entity (MME), Serving GPRS Supporting Node (SGSN), and enhanced Packet Data Gateway (ePDG).

The SGW operates as a boundary point between the Radio Access Network (RAN) and the core network and maintains a data path between the eNodeB and the PDN GW. Also, if UE moves across serving areas by the eNodeB, the SGW acts as an anchor point for local mobility. In other words, packets may be routed through the SGW to ensure mobility within the E-UTRAN (Evolved-UMTS (Universal Mobile Telecommunications System) Terrestrial Radio Access Network defined for the subsequent versions of the 3GPP release 8). Also, the SGW may act as an anchor point for mobility between the E-UTRAN and other 3GPP networks (the RAN defined before the 3GPP release 8, for example, UTRAN or GERAN (GSM (Global System for Mobile Communication)/EDGE (Enhanced Data rates for Global Evolution) Radio Access Network).

The PDN GW corresponds to a termination point of a data interface to a packet data network. The PDN GW may support policy enforcement features, packet filtering, charging support, and so on. Also, the PDN GW may act as an anchor point for mobility management between the 3GPP network and non-3GPP networks (for example, an unreliable network such as the Interworking Wireless Local Area Network (I-WLAN) or reliable networks such as the Code Division Multiple Access (CDMA) network and WiMax).

In the example of a network structure as shown in FIG. 1, the SGW and the PDN GW are treated as separate gateways; however, the two gateways may be implemented according to single gateway configuration option.

The MME performs signaling for the UE's access to the network, supporting allocation, tracking, paging, roaming, handover of network resources, and so on; and control functions. The MME controls control plane functions related to subscribers and session management. The MME manages a plurality of eNodeBs and performs signaling of the conventional gateway's selection for handover to other 2G/3G networks. Also, the MME performs such functions as security procedures, terminal-to-network session handling, idle terminal location management, and so on.

The SGSN deals with all kinds of packet data including the packet data for mobility management and authentication of the user with respect to other 3GPP networks (for example, the GPRS network).

The ePDG acts as a security node with respect to an unreliable, non-3GPP network (for example, I-WLAN, WiFi hotspot, and so on).

As described with respect to FIG. 1, a UE with the IP capability may access the IP service network (for example, the IMS) that a service provider (namely, an operator) provides, via various components within the EPC based not only on the 3GPP access but also on the non-3GPP access.

Also, FIG. 1 illustrates various reference points (for example, S1-U, S1-MME, and so on). The 3GPP system defines a reference point as a conceptual link which connects two functions defined in disparate functional entities of the E-UTAN and the EPC. Table 1 below summarizes reference points shown in FIG. 1. In addition to the examples of FIG. 1, various other reference points may be defined according to network structures.

TABLE 1

| reference point | Description |
|---|---|
| S1-MME | Reference point for the control plane protocol between E-UTRAN and |
| | MME |
| S1-U | Reference point between E-UTRAN and Serving GW for the per bearer |
| | user plane tunneling and inter eNodeB path switching during handover |
| S3 | It enables user and bearer information exchange for inter 3GPP access |
| | network mobility in idle and/or active state. This reference point may be |
| | used intra-PLMN or inter-PLMN (e.g. in the case of Inter-PLMN HO). |
| S4 | It provides related control and mobility support between GPRS core and |
| | the 3GPP anchor function of Serving GW. In addition, if direct tunnel is |
| | not established, it provides the user plane tunneling. |
| S5 | It provides user plane tunneling and tunnel management between Serving |
| | GW and PDN GW. It is used for Serving GW relocation due to UE |
| | mobility if the Serving GW needs to connect to a non-collocated PDN |
| | GW for the required PDN connectivity. |
| S11 | Reference point for the control plane protocol between MME and SGW |
| SGi | It is the reference point between the PDN GW and the packet data |
| | network. Packet data network may be an operator external public or |
| | private packet data network or an intra-operator packet data network (e.g., |
| | for provision of IMS services). This reference point corresponds to Gi for |
| | 3GPP accesses. |

Among the reference points shown in FIG. 1, S2a and S2b corresponds to non-3GPP interfaces. S2a is a reference point which provides reliable, non-3GPP access, related control between PDN GWs, and mobility resources to the user plane. S2b is a reference point which provides related control and mobility resources to the user plane between ePDG and PDN GW.

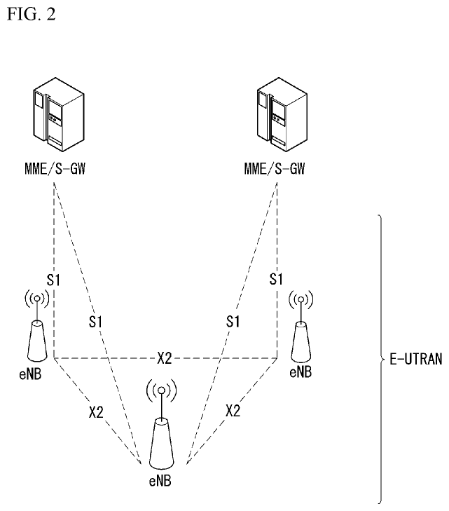

FIG. 2 illustrates one example of an Evolved Universal Terrestrial Radio Access Network (E-UTRAN) to which the present invention may be applied.

The E-UTRAN system is an evolved version of the existing UTRAN system, for example, and is also referred to as 3GPP LTE/LTE-A system. Communication network is widely deployed in order to provide various communication services such as voice (e.g., Voice over Internet Protocol (VoIP)) through IMS and packet data.

Referring to FIG. 2, E-UMTS network includes E-UTRAN, EPC and one or more UEs. The E-UTRAN includes eNBs that provide control plane and user plane protocol, and the eNBs are interconnected with each other by means of the X2 interface.

105] The X2 user plane interface (X2-U) is defined among the eNBs. The X2-U interface provides non-guaranteed delivery of the user plane Packet Data Unit (PDU). The X2 control plane interface (X2-CP) is defined between two neighboring eNBs. The X2-CP performs the functions of context delivery between eNBs, control of user plane tunnel between a source eNB and a target eNB, delivery of handover-related messages, uplink load management, and so on.

The eNB is connected to the UE through a radio interface and is connected to the Evolved Packet Core (EPC) through the S1 interface.

The S1 user plane interface (S1-U) is defined between the eNB and the Serving Gateway (S-GW). The S1 control plane interface (S1-MME) is defined between the eNB and the Mobility Management Entity (MME). The S1 interface performs the functions of EPS bearer service management, non-access stratum (NAS) signaling transport, network sharing, MME load balancing management, and so on. The S1 interface supports many-to-many-relation between the eNB and the MME/S-GW.

The MME may perform various functions such as NAS signaling security, Access Stratum (AS) security control, Core Network (CN) inter-node signaling for supporting mobility between 3GPP access network, IDLE mode UE reachability (including performing paging retransmission and control), Tracking Area Identity (TAI) management (for UEs in idle and active mode), selecting PDN GW and SGW, selecting MME for handover of which the MME is changed, selecting SGSN for handover to 2G or 3G 3GPP access network, roaming, authentication, bearer management function including dedicated bearer establishment, Public Warning System (PWS) (including Earthquake and Tsunami Warning System (ETWS) and Commercial Mobile Alert System (CMAS), supporting message transmission and so on.

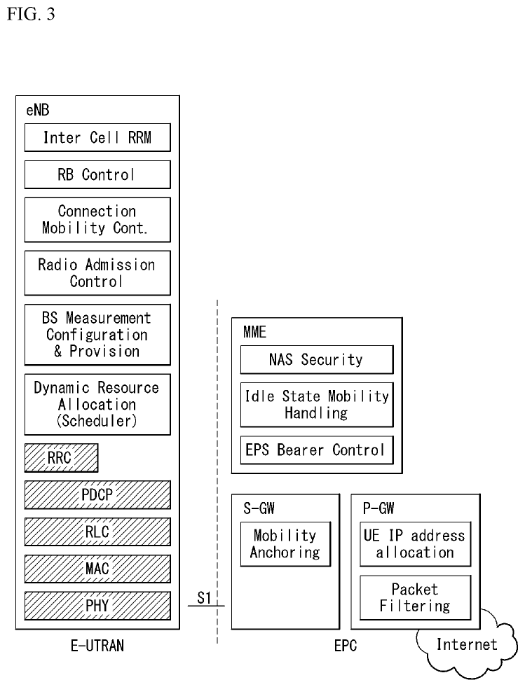

FIG. 3 exemplifies a structure of E-UTRAN and EPC in a wireless communication system to which the present invention may be applied.

Referring to FIG. 3, an eNB may perform functions of selecting gateway (e.g., MME), routing to gateway during radio resource control (RRC) is activated, scheduling and transmitting broadcast channel (BCH), dynamic resource allocation to UE in uplink and downlink, mobility control connection in LTE_ACTIVE state. As described above, the gateway in EPC may perform functions of paging origination, LTE_IDLE state management, ciphering of user plane, bearer control of System Architecture Evolution (SAE), ciphering of NAS signaling and integrity protection.

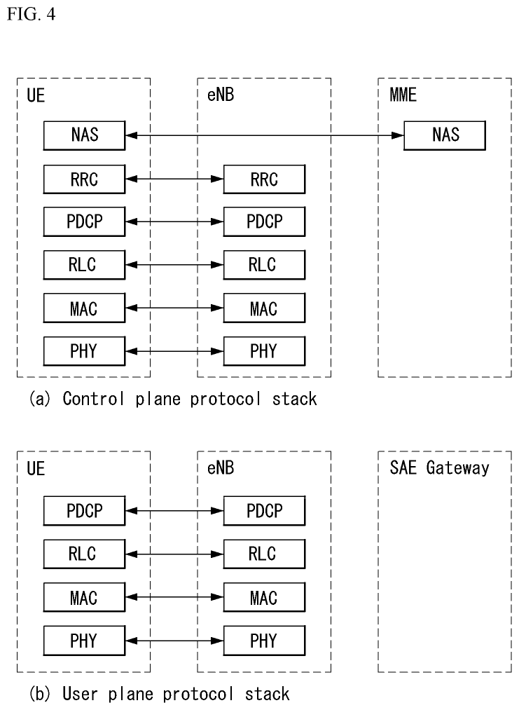

FIG. 4 illustrates a radio interface protocol structure between a UE and an E-UTRAN in a wireless communication system to which the present invention may be applied.

FIG. 4(a) illustrates a radio protocol structure for the control plane, and FIG. 4(b) illustrates a radio protocol structure for the user plane.

Referring to FIG. 4, layers of the radio interface protocol between the UE and the E-UTRAN may be divided into a first layer (L1), a second layer (L2), and a third layer (L3) based on the lower three layers of the Open System Interconnection (OSI) model, widely known in the technical field of communication systems. The radio interface protocol between the UE and the E-UTRAN consists of the physical layer, data link layer, and network layer in the horizontal direction, while in the vertical direction, the radio interface protocol consists of the user plane, which is a protocol stack for delivery of data information, and the control plane, which is a protocol stack for delivery of control signals.

The control plane acts as a path through which control messages used for the UE and the network to manage calls are transmitted. The user plane refers to the path through which the data generated in the application layer, for example, voice data, Internet packet data, and so on are transmitted. In what follows, described will be each layer of the control and the user plane of the radio protocol.

The physical layer (PHY), which is the first layer (L1), provides information transfer service to upper layers by using a physical channel. The physical layer is connected to the Medium Access Control (MAC) layer located at the upper level through a transport channel through which data are transmitted between the MAC layer and the physical layer. Transport channels are classified according to how and with which features data are transmitted through the radio interface. And data are transmitted through the physical channel between different physical layers and between the physical layer of a transmitter and the physical layer of a receiver. The physical layer is modulated according to the Orthogonal Frequency Division Multiplexing (OFDM) scheme and employs time and frequency as radio resources.

A few physical control channels are used in the physical layer. The Physical Downlink Control Channel (PDCCH) informs the UE of resource allocation of the Paging Channel (PCH) and the Downlink Shared Channel (DL-SCH); and Hybrid Automatic Repeat reQuest (HARQ) information related to the Uplink Shared Channel (UL-SCH). Also, the PDCCH may carry a UL grant used for informing the UE of resource allocation of uplink transmission. The Physical Control Format Indicator Channel (PCFICH) informs the UE of the number of OFDM symbols used by PDCCHs and is transmitted at each subframe. The Physical HARQ Indicator Channel (PHICH) carries a HARQ ACK (ACKnowledge)/NACK (Non-ACKnowledge) signal in response to uplink transmission. The Physical Uplink Control Channel (PUCCH) carries uplink control information such as HARQ ACK/NACK with respect to downlink transmission, scheduling request, Channel Quality Indicator (CQI), and so on. The Physical Uplink Shared Channel (PUSCH) carries the UL-SCH.

The MAC layer of the second layer (L2) provides a service to the Radio Link Control (RLC) layer, which is an upper layer thereof, through a logical channel. Also, the MAC layer provides a function of mapping between a logical channel and a transport channel; and multiplexing/demultiplexing a MAC Service Data Unit (SDU) belonging to the logical channel to the transport block, which is provided to a physical channel on the transport channel.

The RLC layer of the second layer (L2) supports reliable data transmission. The function of the RLC layer includes concatenation, segmentation, reassembly of the RLC SDU, and so on. To satisfy varying Quality of Service (QoS) requested by a Radio Bearer (RB), the RLC layer provides three operation modes: Transparent Mode (TM), Unacknowledged Mode (UM), and Acknowledge Mode (AM). The AM RLC provides error correction through Automatic Repeat reQuest (ARQ). Meanwhile, if MAC layer performs the RLC function, the RLC layer may be incorporated into the MAC layer as a functional block.

The Packet Data Convergence Protocol (PDCP) layer of the second layer (L2) performs the function of delivering, header compression, ciphering of user data in the user plane, and so on. Header compression refers to the function of reducing the size of the Internet Protocol (IP) packet header which is relatively large and contains unnecessary control to efficiently transmit IP packets such as the IPv4 (Internet Protocol version 4) or IPv6 (Internet Protocol version 6) packets through a radio interface with narrow bandwidth. The function of the PDCP layer in the control plane includes delivering control plane data and ciphering/integrity protection.

The Radio Resource Control (RRC) layer in the lowest part of the third layer (L3) is defined only in the control plane. The RRC layer performs the role of controlling radio resources between the UE and the network. To this purpose, the UE and the network exchange RRC messages through the RRC layer. The RRC layer controls a logical channel, transport channel, and physical channel with respect to configuration, re-configuration, and release of radio bearers. A radio bearer refers to a logical path that the second layer (L2) provides for data transmission between the UE and the network. Configuring a radio bearer indicates that characteristics of a radio protocol layer and channel are defined to provide specific services; and each individual parameter and operating methods thereof are determined. Radio bearers may be divided into Signaling Radio Bearers (SRBs) and Data RBs (DRBs). An SRB is used as a path for transmitting an RRC message in the control plane, while a DRB is used as a path for transmitting user data in the user plane.

The Non-Access Stratum (NAS) layer in the upper of the RRC layer performs the function of session management, mobility management, and so on.

A cell constituting the base station is set to one of 1.25, 2.5, 5, 10, and 20 MHz bandwidth, providing downlink or uplink transmission services to a plurality of UEs. Different cells may be set to different bandwidths.

Downlink transport channels transmitting data from a network to a UE include a Broadcast Channel (BCH) transmitting system information, PCH transmitting paging messages, DL-SCH transmitting user traffic or control messages, and so on. Traffic or a control message of a downlink multi-cast or broadcast service may be transmitted through the DL-SCH or through a separate downlink Multicast Channel (MCH). Meanwhile, uplink transport channels transmitting data from a UE to a network include a Random Access Channel (RACH) transmitting the initial control message and a Uplink Shared Channel (UL-SCH) transmitting user traffic or control messages.

Logical channels, which are located above the transport channels and are mapped to the transport channels. The logical channels may be distinguished by control channels for delivering control area information and traffic channels for delivering user area information. The control channels include a Broadcast Control Channel (BCCH), a Paging Control Channel (PCCH), a Common Control Channel (CCCH), a dedicated control channel (DCCH), a Multicast Control Channel (MCCH), and etc. The traffic channels include a dedicated traffic channel (DTCH), and a Multicast Traffic Channel (MTCH), etc. The PCCH is a downlink channel that delivers paging information, and is used when network does not know the cell where a UE belongs. The CCCH is used by a UE that does not have RRC connection with network. The MCCH is a point-to-multipoint downlink channel which is used for delivering Multimedia Broadcast and Multicast Service (MBMS) control information from network to UE. The DCCH is a point-to-point bi-directional channel which is used by a UE that has RRC connection delivering dedicated control information between UE and network. The DTCH is a point-to-point channel which is dedicated to a UE for delivering user information that may be existed in uplink and downlink. The MTCH is a point-to-multipoint downlink channel for delivering traffic data from network to UE.

In case of uplink connection between the logical channel and the transport channel, the DCCH may be mapped to UL-SCH, the DTCH may be mapped to UL-SCH, and the CCCH may be mapped to UL-SCH. In case of downlink connection between the logical channel and the transport channel, the BCCH may be mapped to BCH or DL-SCH, the PCCH may be mapped to PCH, the DCCH may be mapped to DL-SCH, the DTCH may be mapped to DL-SCH, the MCCH may be mapped to MCH, and the MTCH may be mapped to MCH.

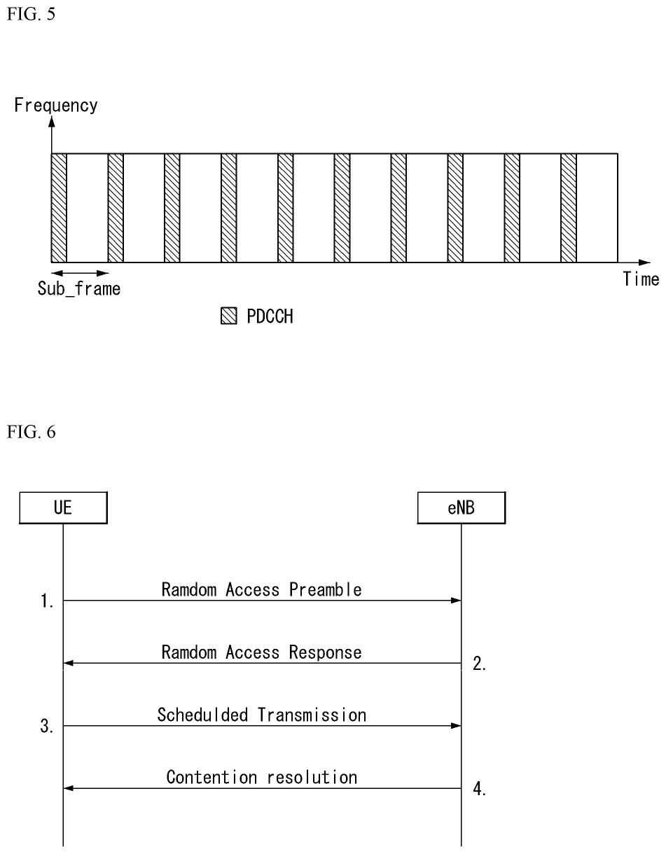

FIG. 5 is a diagram schematically exemplifying a structure of physical channel in a wireless communication system to which the present invention may be applied.

Referring to FIG. 5, the physical channel delivers signaling and data through radio resources including one or more subcarriers in frequency domain and one or more symbols in time domain.

One subframe that has a length of 1.0 ms includes a plurality of symbols. A specific symbol (s) of subframe (e.g., the first symbol of subframe) may be used for PDCCH. The PDCCH carries information for resources which are dynamically allocated (e.g., resource block, modulation and coding scheme (MCS), etc.).

Random Access Procedure

Hereinafter, a random access procedure which is provided in a LTE/LTE-A system will be described.

The random access procedure is performed in case that the UE performs an initial access in a RRC idle state without any RRC connection to an eNB, or the UE performs a RRC connection re-establishment procedure, etc.

The LTE/LTE-A system provides both of the contention-based random access procedure that the UE randomly selects to use one preamble in a specific set and the non-contention-based random access procedure that the eNB uses the random access preamble that is allocated to a specific UE.

FIG. 6 is a diagram for describing the contention-based random access procedure in the wireless communication system to which the present invention may be applied.

(1) Message 1 (Msg 1)

First, the UE randomly selects one random access preamble (RACH preamble) from the set of the random access preamble that is instructed through system information or handover command, selects and transmits physical RACH (PRACH) resource which is able to transmit the random access preamble.

The eNB that receives the random access preamble from the UE decodes the preamble and acquires RA-RNTI. The RA-RNTI associated with the PRACH to which the random access preamble is transmitted is determined according to the time-frequency resource of the random access preamble that is transmitted by the corresponding UE.

(2) Message 2 (Msg 2)

The eNB transmits the random access response that is addressed to RA-RNTI that is acquired through the preamble on the Msg 1 to the UE. The random access response may include RA preamble index/identifier, UL grant that informs the UL radio resource, temporary cell RNTI (TC-RNTI), and time alignment command (TAC). The TAC is the information indicating a time synchronization value that is transmitted by the eNB in order to keep the UL time alignment. The UE renews the UL transmission timing using the time synchronization value. On the renewal of the time synchronization value, the UE renews or restarts the time alignment timer. The UL grant includes the UL resource allocation that is used for transmission of the scheduling message to be described later (Message 3) and the transmit power command (TPC). The TCP is used for determination of the transmission power for the scheduled PUSCH.

The UE, after transmitting the random access preamble, tries to receive the random access response of its own within the random access response window that is instructed by the eNB with system information or handover command, detects the PDCCH masked with RA-RNTI that corresponds to PRACH, and receives the PDSCH that is indicated by the detected PDCCH. The random access response information may be transmitted in a MAC packet data unit and the MAC PDU may be delivered through PDSCH.

The UE terminates monitoring of the random access response if successfully receiving the random access response having the random access preamble index/identifier same as the random access preamble that is transmitted to the eNB. Meanwhile, if the random access response message has not been received until the random access response window is terminated, or if not received a valid random access response having the random access preamble index same as the random access preamble that is transmitted to the eNB, it is considered that the receipt of random access response is failed, and after that, the UE may perform the retransmission of preamble.

(3) Message 3 (Msg 3)

In case that the UE receives the random access response that is effective with the UE itself, the UE processes the information included in the random access response respectively. That is, the UE applies TAC and stores TC-RNTI. Also, by using UL grant, the UE transmits the data stored in the buffer of UE or the data newly generated to the eNB.

In case of the initial access of UE, the RRC connection request that is delivered through CCCH after generating in RRC layer may be transmitted with being included in the message 3. In case of the RRC connection reestablishment procedure, the RRC connection reestablishment request that is delivered through CCCH after generating in RRC layer may be transmitted with being included in the message 3. Additionally, NAS access request message may be included.

The message 3 should include the identifier of UE. There are two ways how to include the identifier of UE. The first method is that the UE transmits the cell RNTI (C-RNTI) of its own through the UL transmission signal corresponding to the UL grant, if the UE has a valid C-RNTI that is already allocated by the corresponding cell before the random access procedure. Meanwhile, if the UE has not been allocated a valid C-RNTI before the random access procedure, the UE transmits including unique identifier of its own (for example, SAE temporary mobile subscriber identity (S-TMSI) or random number). Normally the above unique identifier is longer that C-RNTI.

If transmitting the data corresponding to the UL grant, the UE initiates a contention resolution timer.

(4) Message 4 (Msg 4)

The eNB, in case of receiving the C-RNTI of corresponding UE through the message 3 from the UE, transmits the message 4 to the UE by using the received C-RNTI. Meanwhile, in case of receiving the unique identifier (that is, S-TMSI or random number) through the message 3 from the UE, the eNB transmits the 4 message to the UE by using the TC-RNTI that is allocated from the random access response to the corresponding UE. For example, the 4 message may include the RRC connection setup message.

The UE waits for the instruction of eNB for collision resolution after transmitting the data including the identifier of its own through the UL grant included the random access response. That is, the UE attempts the receipt of PDCCH in order to receive a specific message. There are two ways how to receive the PDCCH. As previously mentioned, in case that the message 3 transmitted in response to the UL grant includes C-RNTI as an identifier of its own, the UE attempts the receipt of PDCCH using the C-RNTI of itself, and in case that the above identifier is the unique identifier (that is, S-TMSI or random number), the UE tries to receive PDCCH using the TC-RNTI that is included in the random access response. After that, in the former case, if the PDCCH is received through the C-RNTI of its own before the contention resolution timer is terminated, the UE determines that the random access procedure is performed and terminates the procedure. In the latter case, if the PDCCH is received through the TC-RNTI before the contention resolution timer is terminated, the UE checks on the data that is delivered by PDSCH, which is addressed by the PDCCH. If the content of the data includes the unique identifier of its own, the UE terminates the random access procedure determining that a normal procedure has been performed. The UE acquires C-RNTI through the 4 message, and after that, the UE and network are to transmit and receive a UE-specific message by using the C-RNTI.

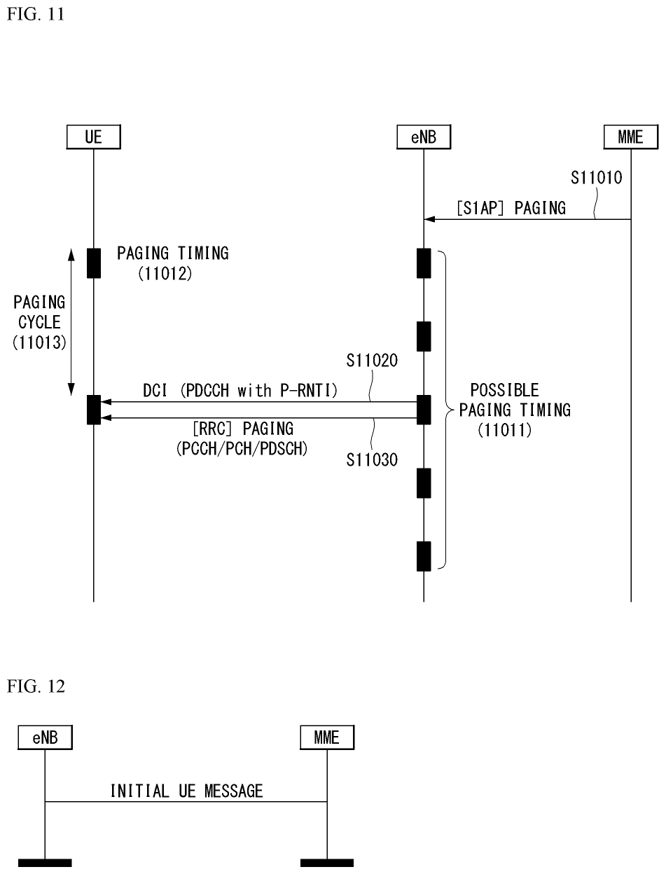

Meanwhile, the operation of the non-contention-based random access procedure, unlike the contention-based random access procedure illustrated in FIG. 11, is terminated with the transmission of message 1 and message 2 only. However, the UE is going to be allocated a random access preamble from the eNB before transmitting the random access preamble to the eNB as the message 1. And the UE transmits the allocated random access preamble to the eNB as the message 1, and terminates the random access procedure by receiving the random access response from the eNB.

Terms used in this specification are described below.

Dedicated bearer: an EPS bearer associated with an uplink packet filter(s) within a UE and a downlink packet filter(s) within a P-GW. In this case, only a specific packet is matched with the filter(s).

Default bearer: an EPS bearer established even new PDN connection. Context of a default bearer is maintained during the lifetime of a PDN connection.

EPS mobility management (EMM)-EMM-NULL state: an EPS service within a UE is deactivated. Any EPS mobility management function is not performed.

EMM-DEREGISTERED state: in the EMM-DEREGISTERED state, EMM context is not established and an MME is not notified of a UE location. Accordingly, the UE is unreachable by the MME. In order to establish EMM context, the UE needs to start an Attach or combined Attach procedure.

EMM-REGISTERED state: In the EMM-REGISTERED state, EMM context within a UE has been established and default EPS bearer context has been activated. When a UE is in the EMM-IDLE mode, an MME is notified of a UE location with accuracy of a list of TAs including a specific number of a TA. The UE may initiate the transmission and reception of user data and signaling information and may respond to paging. Furthermore, a TAU or combined TAU procedure is performed.

EMM-CONNECTED mode: when an NAS signaling connection is set up between a UE and a network, the UE is the EMM-CONNECTED mode. The term “EMM-CONNECTED” may be referred to as a term “ECM-CONNECTED state.”

EMM-IDLE mode: when an NAS signaling connection is not present between a UE and a network (i.e., an EMM-IDLE mode without suspend indication) or RRC connection suspend is indicated by a lower layer (i.e., an EMM-IDLE mode with suspend indication), the UE is in the EMM-IDLE mode. The term “EMM-IDLE” may be referred to as a term “ECM-IDLE state.”

EMM context: when an Attach procedure is successfully completed, EMM context is established between a UE and an MME.

Control plane CIoT EPS optimization: signaling optimization that enables the efficient transport of user data (IP, non-IP or SMS) through a control plane via an MME. This may optionally include the header compression of IP data.

User plane CIoT EPS optimization: signaling optimization that enables the efficient transport of user data (IP or non-IP) through a user plane.

EPS service(s): a service(s) provided by a PS domain.

NAS signaling connection: a peer-to-peer Si mode connection between a UE and an MME. An NAS signaling connection has a concatenation of an RRC connection via an LTE-Uu interface and an S IAP connection via an Si interface.

UE using EPS services with control plane CIoT EPS optimization: UE attached for EPS services with control plane CIOT EPS optimization approved by a network

Non-access stratum (NAS): a functional layer for exchanging an UMTS, signaling between a UE and a core network in an EPS protocol stack, and a traffic message. This has a main function of supporting the mobility of a UE and supporting a session management procedure of establishing and maintaining an IP connection between a UE and a PDN GW.

Access stratum (AS): this means a protocol layer under the NAS layer on the interface protocol between an E-UTRAN (eNB) and a UE or between an E-UTRAN (eNB) and an MME. For example, in the control plane protocol stack, the RRC layer, PDCP layer, RLC layer, MAC layer and PHY layer may be collectively referred to as an AS layer or any one of the layers may be referred to as an AS layer. Or, in the user plane protocol stack, the PDCP layer, RLC layer, MAC layer and PHY layer may be collectively referred to as an AS layer or any one of the layers may be referred to as an AS layer.

S1 mode: a mode applied to a system having functional separation according to the use of an S1 interface between a radio access network and a core network. The S1 mode includes a WB-S1 mode and an NB-S1 mode.

NB-S1 mode: this mode is applied by a UE when a serving radio access network of the UE provides access to a network service (via E-UTRA) based on a narrow band (NB)-Internet of things (IoT).

WB-S1 mode: this mode is applied when a system operates in the Si mode, but is not the NB-S1 mode.

In 3GPP Release 14, service requirements are being worked in SA1 so that non-public safety UEs receives a network connection service through a relay UE. As a UE receiving the network connection service through the relay UE, a wearable device is representatively considered.

Even in SA2 and RAN WG, each of FS_REAR (a remote UE connection through the relay UE) and F2D2D (enhancement of LTE device to device communication and a relay between a UE and a network for Internet of things (IoT) and wearables) as a study item description (SID) for a release (Rel)-13 relay is approved and a study related thereto is in progress.

Characteristically, an F2D2D study item is under discussion to target low power, low rate, and low complexity/low cost devices.

In the FS_REAR study item, in particular, it is discussed whether a common solution is possible for asymmetric uplink/downlink connection (that is, uplink transmission via PC5 and direct downlink transmission via Uu with ProSe UE-to-Network Relay) and symmetric uplink/downlink connection.

As described above, two cases, the asymmetric uplink/downlink and the symmetric uplink/downlink are considered.

Here, the ‘asymmetric uplink/downlink’ means that a remote UE (UE) uses a direct link with the relay UE for the uplink transmission and uses the Uu interface from the base station for the downlink transmission.

The ‘symmetric uplink/downlink’ means that the remote UE uses the direct link with the relay UE for both the uplink transmission and the downlink transmission.

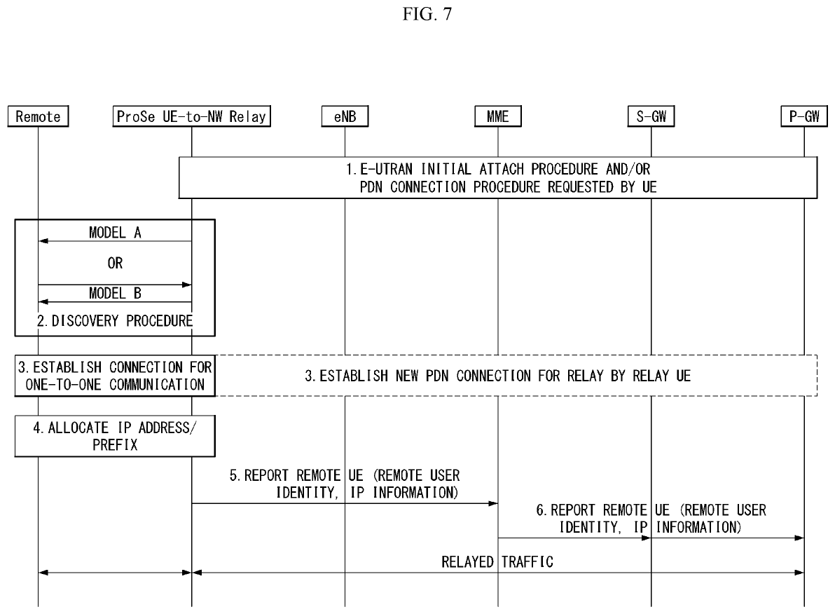

FIG. 7 is a diagram illustrating a ProSe UE-to-Network Relay procedure in a wireless communication system to which the present invention can be applied.

FIG. 11 is a diagram illustrating a ProSe UE-to-Network Relay procedure in a wireless communication system to which the present invention can be applied.

1. The ProSe UE-to-Network Relay performs an initial E-UTRAN attach (if not already attached) and/or establishes a PDN connection for the relay (if there is no suitable PDN connection for the relay). In the case of IPv6, the ProSe UE-to-Network Relay obtains an IPv6 prefix from a network via a prefix delegation function.

2. The remote UE performs discovery of the ProSe UE-to-Network Relay using model A or model B discovery.

3. The remote UE selects the ProSe UE-to-Network Relay and establishes a connection for one-to-one Prose direct communication. If there is no PDN connection associated with the ProSe relay UE identifier (ID) or if an additional PDN connection is needed for the relay, the ProSe UE-to-Network Relay initiates a new PDN connection establishment procedure.

4. An IPv6 prefix or an IPv4 address is allocated for the remote UE. From this time, the uplink and downlink relay can be started.

5. The ProSe UE-to-Network Relay transmits a remote UE report (including a remote user ID and IP info) message to the MME for a PDN connection associated with the relay. The remote user ID is an identifier (provided through user info) of the remote UE user that was successfully connected in step 3. The MME stores the remote user ID(s) and the associated IP info in the EPS bearer context of the ProSe UE-to-Network Relay for the PDN connection associated with the relay.

6. The MME transmits the remote UE report message to the S-GW, and the S-GW transmits the message to the P-GW of the UE-to-Network relay UE. The MME may report multiple remote UEs in one remote UE report message.

The following principles may apply for IP info:

For IPv4, the UE-to-Network Relay reports the transmission control protocol (TCP)/user datagram protocol (UDP) port range allocated to the dedicated remote UE(s) (along with the remote user ID);

For IPv6, the UE-to-Network Relay reports the IPv6 prefix(s) allocated to the dedicated remote UE (s) (along with the remote user ID).

When the remote UE is disconnected from the ProSe UE-to-Network Relay, the remote UE report message is transmitted to the MME, the S-GW and the P-GW to inform that the remote UE(s) are disconnected (for example, when an explicit layer-2 link is released or there is no keep alive message via PC5).

In the case of a TAU that includes an MME change, the relevant IP info corresponding to the remote UE(s) connected to the remote user ID is transmitted to a new MME as part of the EPS bearer context delivery for the ProSe UE-to-Network Relay.

After being connected to the ProSe UE-to-Network Relay, the remote UE continues to measure the signal strength of the discovery messages transmitted by the ProSe UE-to-Network Relay for the relay selection (that is, UE-to-Network Relay discovery announcement message in model A or UE-to-Network Relay discovery response message in model B). In the case of model B, to measure PC5 link quality, the remote UE periodically transmits a UE-to-Network Relay discovery solicitation message. This message includes the ProSe relay UE ID of the serving ProSe UE-to-Network Relay. If the ProSe relay UE ID is included in this message, only the ProSe UE-to-Network Relay having this ProSe relay UE ID responds to the UE-to-Network Relay discovery solicitation message.

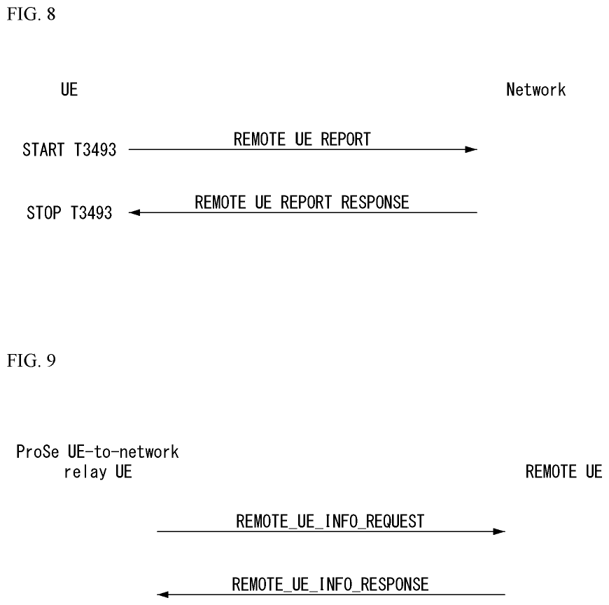

FIG. 8 is a diagram illustrating a remote UE reporting procedure in a wireless communication system to which the present invention can be applied.

The purpose of the remote UE reporting procedure is to inform a network that for a UE serving as the ProSe UE-to-Network Relay, a remote UE is not connected to the ProSe UE-to-Network Relay or is not connected to the ProSe UE-to-Network Relay.

As illustrated in FIG. 8, the UE transmits a REMOTE UE REPORT message to the network, starts timer T3493, enters a PROCEDURE TRANSACTION PENDING state, and starts the remote UE reporting procedure.

The UE may include information of a remote UE newly connected to or disconnected from the network in a REMOTE UE REPORT message.

If any encrypted IMSI remote UE identity is included in the REMOTE UE REPORT message, the UE may include the corresponding ProSe Key management function address in the REMOTE UE REPORT message.

The UE may include, in the REMOTE UE REPORT message, a default EPS bearer identity of the PDN connection associated with the remote UE which is connected to or disconnected from the ProSe UE-to-Network Relay.

After receiving the REMOTE UE REPORT message, the MME transmits a REMOTE UE REPORT RESPONSE message to the UE. The MME may include PTI in the REMOTE UE REPORT message.

After receiving the REMOTE UE REPORT RESPONSE message, the UE stops timer T3493 and enters the PROCEDURE TRANSACTION INACTIVE state.

In an abnormal case, when the timer T3493 expires first, the UE transmits the REMOTE UE REPORT message back to the MME and resets the timer T3493 to restart.

This retransmission process is repeated twice. That is, when the timer T3493 expires a third time, the UE stops the procedure and releases any resources allocated for this procedure.

Table 2 below shows an example of an information element (IE) constituting the REMOTE UE REPORT message.

TABLE 2

| IEI | Information Element | Type/Reference | Presence | Format | Length |
|---|---|---|---|---|---|
| | Protocol discriminator | Protocol discriminator | M | V | ½ |
| | | 9.2 | | | |
| | EPS bearer identity | EPS bearer identity | M | V | ½ |
| | | 9.3.2 | | | |
| | Procedure transaction | Procedure transaction identity | M | V | 1 |
| | identity | 9.4 | | | |
| | Remote UE report message | Message type | M | V | 1 |
| | identity | 9.8 | | | |
| 79 | Remote UE Context | Remote UE context list IE | O | TLV-E | 3-65538 |
| | Connected | 9.9.4.20 | | | |
| 7A | Remote UE Context | Remote UE context list IE | O | TLV-E | 3-65538 |
| | Disconnected | 9.9.4.20 | | | |
| 6F | ProSe Key Management | PKMF address IE | O | TLV | 3-19 |
| | Function address | 9.9.4.21 | | | |

remote UE Context Connected: IE included in the message by the UE serving as the ProSe UE-to-Network Relay to provide newly connected remote UE information to the network (see 3GPP TS 23.303).

remote UE Context Disconnected: IE included in the message by the UE serving as the ProSe UE-to-Network Relay to provide the connected remote UE information to the network (see 3GPP TS 23.303).

ProSe Key Management Function Address: IE included in the message to provide the address of the ProSe Key Management Function associated with the remote UE which is connected to or disconnected from the UE serving as the ProSe UE-to-Network Relay.

Table 3 below shows an example of an information element (IE) constituting a REMOTE UE REPORT RESPONSE message.

TABLE 3

| IEI | Information Element | Type/Reference | Presence | Format | Length |
|---|---|---|---|---|---|
| | Protocol discriminator | Protocol discriminator | M | V | ½ |
| | | 9.2 | | | |
| | EPS bearer identity | EPS bearer identity | M | V | ½ |
| | | 9.3.2 | | | |
| | Procedure transaction | Procedure transaction | M | V | 1 |
| | identity | identity | | | |
| | | 9.4 | | | |
| | Remote UE report | Message type | M | V | 1 |
| | response | 9.8 | | | |
| | message identity | | | | |

The following information element (IE) may be used for messages of a remote UE reporting procedure.

Remote UE Context List

The remote UE context list information element may provide an identity of a remote UE connected to or disconnected from the UE serving as the ProSe UE-to-Network Relay and may optionally provide an IP address.

The remote UE context list information element may be coded as shown in Tables 4 and 5 below.

The remote UE context list is a type 6 information element with a minimum length of 5 octets and a maximum length of 65538 octets.

TABLE 4

| | |
|---|---|
| 8 7 6 5 4 3 2 1 | |
| Remote UE context fist IEI | octet 1 |
| Length of Remote UE context list contents | octet 2 to 3 |
| Number of Remote UE contexts | octet 4 |
| Remote UE context 1 | octet 5 to a |
| . . . | |
| Remote UE context k | octet b |
| | octet m |

TABLE 5

Remote UE context (octet 5 etc)
The contents of remote UE context are applicable for one dedicated
UE and are coded as illustrated in table 6 and table 7.
(The contents of Remote UE context are applicable for one
individual UE and are coded as shown in table 7 and table 8)

TABLE 6

| 8 7 6 5 4 3 2 1 | | | |
|---|---|---|---|
| Length of Remote UE context | | | octet 1 |
| Number of user identities | | | octet 2 |
| Length of user identity 1 | | | octet 3 |
| User identity 1 digit 1 | odd/ | Type of user | octet 4 |
| | even | identity 1 | |
| | indic | | |
| User identity 1 digit p + 1 | User identity 1 digit p | | octet 5* |
| . . . | | | |
| Length of user identity v | | | octet m |
| User identity v digit 1 | odd/ | Type of user | octet m + 1 |
| | even | identity v | |
| | indic | | |

| | | |
|---|---|---|
| User identity v digit p + 1 | User identity v digit p | octet m + 2* |

| | | |
|---|---|---|
| Spare | Address type | octet j |

| | |
|---|---|
| Address information | octet j + 1 |
| | octet j + k |

Odd/even indication (octet 4)
Bit
4
0 even number of identity digits
1 odd number of identity digits
Type of user identity (octet 4)
Bits
3 2 1
0 0 1 Encrypted IMSI
0 1 0 IMSI
0 1 1 MSISDN
1 0 0 IMEI
1 0 1 IMEISV
All other values are reserved.
Identity digits (octet 4 etc)
For the Encrypted IMSI, this field is coded as a 128-bit string. Bits
5 to 8 of octet 4 are not part of the encrypted IMSI and shall be
coded as zero. Bit 8 of octet 5 represents the most significant bit of
the encrypted IMSI and bit 1 of octet 21 the least significant bit.
For the IMSI, this field is coded using BCD coding. If the number
of identity digits is even then bits 5 to 8 of the last octet shall be
filled with an end mark coded as “1111”. The format of IMSI is
described in 3GPP TS 23.003 [2].
For the MSISDN, this field is coded using BCD coding. The
format of MSISDN is described in 3GPP TS 23.003 [2].
For the IMEI, this field is coded using BCD coding. The format of
the IMEI is described in 3GPP TS 23.003 [2].
For the IMEISV, this field is coded using BCD coding. Bits 5 to 8
of the last octet shall be filled with an end mark coded as “1111”.
The format of the IMEISV is described in 3GPP TS 23.003 [2].
Bits 4 to 8 of octet j are spare and shall be coded as zero.
Address type (octet j)
Bits
3 2 1
0 0 0 No IP Info
0 0 1 IPv4
0 1 0 IPv6
All other values are reserved.

If the address type indicates IPv4, address information from octet j+1 to octet j+6 includes an IPv4 address and a port number. Bit 8 of octet j+1 represents the most significant bit of the IP address and bit 1 of octet j+4 represents the least significant bit.

Bit 8 of octet j+5 represents the most significant bit of the port number and bit 1 of octet j+6 represents the least significant bit.

If the address type indicates IPv6, the address information from octet j+1 to octet j+8 includes the/64 IPv6 prefix of the remote UE. Bit 8 of octet j+1 represents the most significant bit of the /64 IPv6 prefix and bit 1 of octet j+8 represents the least significant bit.

If the address type indicates no IP information, no address information octets are included.

PKMF Address

The PKMF address information element may provide an IP address of a ProSe Key Management Function associated with a remote UE which is connected to or disconnected from the UE serving as the ProSe UE-to-Network Relay.

The PKMF address information element may be coded as shown in Tables 8 and 9 below.

The PKMF address is a type 4 information element with a minimum length of 3 octets and a maximum length of 19 octets.

TABLE 8

| 8 7 6 5 4 3 2 1 | | |
|---|---|---|
| PKMF address IEI | | octet 1 |
| Length of PKMF address contents | | octet 2 |
| Spare | Address type | octet 3 |

| | |
|---|---|
| Address information | octet 4 |

octet 4 + k

Bits 4 to 8 of octet 1 are spare and shall be coded as zero.
Address type (octet 1)
Bits
3 2 1
0 0 1 IPv4
0 1 0 IPv6
All other values are reserved.

If the address type indicates IPv4, the address information from octet 4 to octet 7 includes the IPv4 address. Bit 8 of octet 4 represents the most significant bit of the IP address and bit 1 of octet 7 represents the least significant bit.

If the address type indicates IPv4, the address information from octet 4 to octet 19 includes the IPv4 address. Bit 8 of octet 4 represents the most significant bit of the IP address and bit 1 of octet 19 represents the least significant bit.

In order for the relay UE to perform a remote UE reporting procedure, information on the remote UE is required. Accordingly, the relay UE may request and obtain the information on the remote UE through the PC5 link.

Hereinafter, a procedure for obtaining information on a remote UE by a relay UE will be described in detail.

Remote UE Information Request Procedure

FIG. 9 is a diagram illustrating a remote UE information request procedure in the wireless communication system to which the present invention can be applied.

The remote UE information request procedure refers to a procedure for the serving ProSe UE-to-Network relay UE to obtain information from the remote UE served by the relay. The remote UE information request procedure may be initiated only by the ProSe UE-to-Network relay UE through a link (for example, PC5 link, etc.) established between the remote UE and the ProSe UE-to-Network relay UE.

Prior to initiating the remote UE information request procedure, a direct link is successfully established between the remote UE and the ProSe UE-to-Network relay UE.

The ProSe UE-to-Network relay UE generates a REMOTE_UE_INFO_REQUEST message including the remote UE Information Type IE set as the requested type of information, and transmits the generated message to a lower layer in order to be transmitted along with Layer 2 ID (that is, the ProSe UE) of the remote UE for unicast communication. ID) and Layer 2 ID (that is, ProSe relay UE ID) of the ProSe UE-to-Network relay UE for unicast communication.

After the remote UE receives the REMOTE_UE_INFO_REQUEST message, the remote UE includes the type of requested information in the REMOTE_UE_INFO_RESPONSE message.

When the remote UE receives the REMOTE_UE_INFO_REQUEST message, the ProSe UE-to-Network relay UE may temporarily store the information provided by the remote UE and report the remote UE identity to the MME (see 3GPP TS 24.301).

After the REMOTE_UE_INFO_REQUEST message is successfully transmitted to the remote UE, if there is no response from the remote UE, the ProSe UE-to-Network relay UE retransmits the REMOTE_UE_INFO_REQUEST message.

Hereinafter, the PC5 signaling messages used in the remote UE information request procedure will be described.

REMOTE UE INFO REQUEST

The REMOTE_UE_INFO_REQUEST message is transmitted to the remote UE by the ProSe UE-to-Network relay UE in order to initiate the remote UE information request procedure.

Table 10 below shows an example of IE included in the REMOTE_UE_INFO_REQUEST message.

TABLE 10

| IEI | Information Element | Type/Reference | Presence | Format | Length |
|---|---|---|---|---|---|
| | REMOTE_UE_INFO_REQUEST | Message Type | M | V | 1 |
| | message identity | 12.5.1.1 | | | |
| | Sequence Number | Sequence Number | M | V | 2 |
| | | 12.5.1.2 | | | |
| | Remote UE Information Type | Remote UE | M | V | 1 |
| | | Information Type | | | |
| | | 12.5.1.35 | | | |

REMOTE UE INFO RESPONSE

The REMOTE_UE_INFO_RESPONSE message is transmitted to the ProSe UE-to-Network relay UE by the remote UE as a response to the remote UE information request of the ProSe UE-to-Network relay UE.

Table 11 below shows an example of IE included in the REMOTE_UE_INFO_REQUEST message.

TABLE 11

| IEI | Information Element | Type/Reference | Presence | Format | Length |
|---|---|---|---|---|---|
| | REMOTE_UE_INFO_RESPONSE | Message Type | M | V | 1 |
| | message identity | 12.5.1.1 | | | |
| | Sequence Number | Sequence Number | M | V | 2 |
| | | 12.5.1.2 | | | |
| 25 | IMEI | IMEI | O | TV | 9 or 10 |
| | | 12.5.1.36 | | | |

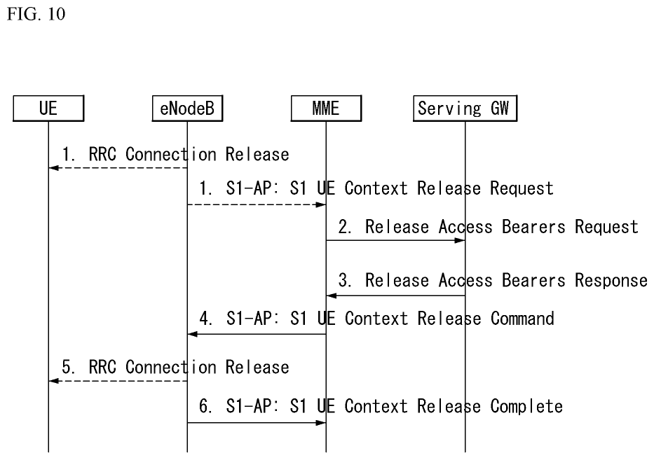

FIG. 10 is a diagram illustrating an SI release procedure in the wireless communication system to which the present invention can be applied.

FIG. 10 illustrates both an eNB-initiated and an MME-initiated S1 release procedure.

1a. In a particular case, the base station may release the signaling connection of the terminal before or with the request of the MME to release an S1 context (For example, in the case where the base station initiates an RRC Connection Release for CS fallback by redirection, and the like).

1b. When the base station detects that the signaling connection of the terminal and all radio bearers for the terminal need to be released, the base station transmits an S1 UE context release request (cause) message to the MME.

Here, the cause indicates the reason for the release (for example, O&M Intervention, unspecified failure, user inactivity, repeated integrity check failure or release due to UE generated signaling connection release).

Here, step 1 is performed only when an eNB-initiated S1 release procedure is considered. When the MME-initiated S1 release procedure is considered, step 1 is not performed and the procedure starts from step 2.

2. The MME transmits a Release Access Bearers Request (Abnormal Release of Radio Link Indication) message to the S-GW to request the S-GW to release all the S1-U bearers for the terminal. This message is triggered by the S1 Release Request message or another MME event from the base station. The abnormal release indication of the radio link is included when the S1 release procedure is due to the abnormal release of the radio link.

3. The S-GW releases all base station related information (address and tunnel end point identifier (TEID)) and responds to the MME with a Release Access Bearers Response message. Other elements of the S-GW context of the terminal are not affected.

The S-GW maintains the S1-U configuration that the S-GW allocates for the bearer of the UE.

When the downlink packet arrives for the terminal, the S-GW starts to buffer the received downlink packet for the terminal and initiates a network-triggered Service Request procedure.

Based on the operator policy, the S-GW may be used to make subsequent decisions to trigger PDN charging interruption using an indication of the abnormal release of the received radio link.

4. The MME releases S1 by transmitting an S1 UE Context Release Command (cause) message to the base station.

5. If the RRC connection has not been released yet, the base station transmits an RRC Connection Release message to the terminal in an acknowledge mode (AM). When the RRC Connection Release message is received by the terminal, the base station deletes the context of the terminal.

6. The base station confirms the S1 release by returning an S1 Context Release Complete (ECGI, TAI) message to the MME. In addition, the signaling connection between the MME and the base station for the terminal is released. This step is performed immediately after step 4, for example, in order not to be delayed in a situation in which the terminal does not receive a response of the RRC Connection Release.

The MME deletes base station related information (“eNodeB Address in Use for S1-MME”, “MME UE S1 AP ID”, and “eNB UE S1AP ID”) from the MME context of the terminal. However, the MME maintains the remaining information of the MME context of the terminal including S1-U configuration information (address and TEID) of the S-GW. All non-guaranteed bit rate (EPR) EPS bearers that have been established for the terminal are preserved in the MME and S-GW.

If the cause of S1 release is user inactivity and inter-RAT redirection, the MME preserves the GBR bearer. If the cause of the S1 release is CS fallback triggered, a procedure for bearer handling may be performed. If not (for example, when the radio disconnection from the terminal occurs, the S1 signaling is disconnected, when the base station fails, and the like), the MME triggers an MME Initiated Dedicated Bearer Deactivation procedure for the GBR bearer of the terminal after the Si release procedure is completed.

When Local IP Access (LIPA) is enabled for the PDN connection, the Home eNB (HeNB) informs a collocated Local Gateway (L-GW) of the enabled situation with internal signaling in order to release a direct user plane path to the HeNB. In order to release the plane path). After the direct user plane path is released, when a downlink packet for the terminal arrives, the L-GW transmits a first packet to the S-GW through an S5 tunnel in order for the S-GW to initiate a Network-triggered Service Request procedure.

Paging

The paging procedure may be used to transmit paging information to a UE in RRC_IDLE mode in a network, inform a terminal, which is in RRC_IDLE/RRC_CONNECTED mode or in RRC_IDLE/RRC_CONNECTED mode, of a change in system information, inform a terminal, whic is in an RRC_IDLE/RRC_CONNECTED mode, of ETWS primary notification and/or ETWS secondary notification, or inform a terminal, which is in an RRC_IDLE/RRC_CONNECTED mode, of CMAS notification.

FIG. 11 is a diagram illustrating a paging procedure in the wireless communication system to which the present invention can be applied.

Referring to FIG. 11, the MME initiates a paging procedure by transmitting an S1AP paging message to the base station (S11010).

The location of the terminal in the ECM-IDLE state is managed by the MME based on a tracking area (TA). In this case, since the terminal may be registered in one or more TAs, the MME may transmit to a plurality of eNBs covering cells belonging to the registered TA(s). Here, each cell may belong to only one TA, and each eNB may include cells belonging to different TAs.

Here, the MME transmits a paging message to each eNB through an S1AP interface. Hereinafter, this will be referred to as an ‘S1AP PAGING message’.

Table 12 and Table 13 illustrate the S1AP PAGING message.

TABLE 12

| | | | IE type | | | |
|---|---|---|---|---|---|---|
| | | | and | Semantics | | Assigned |
| IE/Group Name | Presence | Range | reference | description | Criticality | Criticality |
| Message Type | M | | 9.2.1.1 | | YES | ignore |
| UE Identity | M | | 9.2.3.10 | | YES | ignore |
| Index value | | | | | | |
| UE Paging | M | | 9.2.3.13 | | YES | ignore |
| Identity | | | | | | |
| Paging DRX | O | | 9.2.1.16 | | YES | ignore |
| CN Domain | M | | 9.2.3.22 | | YES | ignore |
| List of TAIs | | 1 | | | YES | ignore |
| >TAI List Item | | 1 . . . <maxnoofTAIs> | | | EACH | ignore |
| >>TAI | M | | 9.2.3.16 | | — | |
| CSG Id List | | 0 . . . 1 | | | GLOBAL | ignore |
| >CSG Id | | 1 . . . <maxnoofCSGId> | 9.2.1.62 | | — | |
| Paging Priority | O | | 9.2.1.78 | | YES | ignore |
| UE Radio | O | | 9.2.1.98 | | YES | ignore |
| Capability for | | | | | | |
| Paging | | | | | | |
| Assistance Data | O | | 9.2.1.103 | | YES | ignore |
| for Paging | | | | | | |
| Paging eDRX | O | | 9.2.1.111 | | YES | ignore |
| Information | | | | | | |
| Extended UE | O | | 9.2.3.46 | | YES | ignore |
| Identity Index | | | | | | |
| Value | | | | | | |
| NB-IoT Paging | O | | 9.2.1.115 | | YES | ignore |
| eDRX | | | | | | |
| Information | | | | | | |
| NB-IoT UE | O | | 9.2.3.47 | | YES | ignore |
| Identity Index | | | | | | |
| value | | | | | | |

TABLE 13

| Range bound | Explanation |
|---|---|
| maxnoofTAIs | Maximum no. of TAIs. Value is 256. |
| maxnoofCSGIds | Maximum no. of CSG Ids within the CSG Id List. |
| | Value is 256. |

Referring to Tables 12 and 13, the IE/Group Name indicates a name of an information element (IE) or an information element group (IE group). ‘M’ in a presence field indicates an IE/IE group always included in the message as mandatory IE, ‘O’ indicates an IE/IE group which is an optional IE and may or may not be included in a message, and ‘C’ indicates an IE/IE group which is a conditional IE and is included in a message only when a specific condition is satisfied. A range field indicates the number of repetitive IEs/IE groups that can be repeated.

An IE type and reference field indicates the type of the IE (for example, enumerated data, integer, octet string, and the like) and indicates a range of values when the range of values that the IE can have exists.

A criticality field indicates criticality information applied to the IE/IE group. The criticality information refers to information indicating how to operate at the receiver when the receiver does not understand all or a part of the IE/IE group. ‘-’ indicates that the criticality information is not applied, and ‘YES’ indicates that the criticality information is applied. ‘GLOBAL’ indicates that one criticality information is common to IE and the repetition of the IE. ‘EACH’ indicates that each of the repetitions of the IE has unique criticality information. An assigned criticality field indicates actual criticality information.

The information element (IE) or IE group included in the S1AP PAGING message will be described in more detail as follows.

Message Type IE uniquely identifies the transmitted message.

UE Identity Index value IE is used by an eNB to calculate a paging frame (PF) (for example, UE Identity Index=UE IMSI mod 1024).

UE Paging Identity IE is an identity for identifying a paged terminal and is indicated by one of IMSI and SAE Temporary Mobile Subscriber Identity (S-TMSI). The S-TMSI means an identity capable of uniquely identifying a terminal in one MME group.

Paging DRX IE is used to calculate a paging frame (PF) at the base station when the terminal uses a UE-specific DRX cycle length. The terminal may specify the DRX cycle length in an attach request message or a tracking area update (TAU) message.

CN Domain IE indicates whether paging occurs in a circuit switched (CS) domain or a packet switched (PS) domain.

The tracking area identity list (TAI List) IE is used to inform the base station of a TA to which a paging message should be broadcast. The TAI means an identity used to uniquely identify the TA.

A closed subscriber group (CSG) identity list (CSG ID List) IE indicates a CSG set to which a terminal is subscribed. This prevents the base station from paging to a terminal in the CSG cell to which the terminal is not subscribed.

The eNB that receives the S1AP paging message from the MME configures a paging message (hereinafter, referred to as an ‘RRC Paging message’). Table 14 illustrates the RRC Paging message.

Table 14 illustrates the RRC Paging message

TABLE 14
-- ASN1STARTPaging ::= SEQUENCE { pagingRecordList PagingRecordList
OPTIONAL, -- Need ON systemInfoModification ENUMERATED {true}
OPTIONAL, -- Need ON etws-Indication ENUMERATED {true} OPTIONAL, --
Need ON nonCriticalExtension Paging-v890-IEs OPTIONAL -- Need
OP}Paging-v890-IEs ::= SEQUENCE { lateNonCriticalExtension OCTET STRING
OPTIONAL, -- Need OP nonCriticalExtension Paging-v920-IEs OPTIONAL -- Need
OP}Paging-v920-IEs ::= SEQUENCE { cmas-Indication-r9 ENUMERATED {true}
OPTIONAL, -- Need ON nonCriticalExtension Paging-v1130-IEs OPTIONAL --
Need OP}Paging-v1130-IEs ::= SEQUENCE { eab-ParamModification-r11
ENUMERATED {true} OPTIONAL, -- Need ON nonCriticalExtension SEQUENCE
{ } OPTIONAL -- Need OP}PagingRecordList ::= SEQUENCE (SIZE
(1..maxPageRec)) OF PagingRecordPagingRecord ::= SEQUENCE { ue-Identity
PagingUE-Identity, cn-Domain ENUMERATED {ps, cs}, ...}PagingUE-Identity ::=
CHOICE { s-TMSI S-TMSI, imsi IMSL, ...}IMSI ::= SEQUENCE (SIZE (6..21)) OF
IMSI-DigitMSI-Digit ::= INTEGER (0..9)-- ASN1STOP

Referring to Table 14, a single RRC paging message may carry information of multiple S1AP paging messages. That is, the RRC paging message may include multiple paging records (for example, 16) for paging multiple terminals.

Each paging record includes a ue-Identity field and a cn-domain field. This is content transmitted from the S1AP Paging message.

A systemInfoModification field is not transmitted from the S1AP Paging message and is generated by the base station. This field is used to trigger the terminal to reacquire a set of system information blocks (SIBs).

An Extended Access Barring (EAB) parameter change (eab-ParamModification) field is used to indicate EAB parameter (SIB 14) change.

An etws-Indication field is not transmitted from the S1AP Paging message and is generated by the base station. This field applies only to an ETWS capable UE and is used to trigger the UE to reacquire SIB 1. SIB 1 content indicates the ETWS content in the SIB 10 and SIB 11 to the terminal.

A cmas-indication field is applied only to the CMAS capable UE and is used to trigger the UE to reacquire SIB 1. The SIB 1 content indicates the CMAS content in SIB 12 to a terminal.

The eNB configuring the RRC paging message as described above transmits downlink control information (DCI) attached with a cyclic redundancy check (CRC) scrambled with Paging-RNTI (P-RNTI) from PDCCH to a terminal (S11020), and transmits the RRC paging message to the terminal through PDSCH (S11030).

That is, the base station transmits an RRC paging message to a terminal through a PCCH logical channel, a PCH transport channel, and a PDSCH physical channel.

In more detail, the base station determines a PDCCH format according to the DCI to be transmitted to a terminal, and attaches the CRC to the DCI. In the CRC, a radio network temporary identifier (RNTI) is scrambled (or masked) according to an owner or applications of the PDCCH. If the PDCCH is for a specific UE, a unique identifier (for example, cell-RNTI) of the terminal may be masked to the CRC. Alternatively, if the PDCCH is for a specific UE, a paging indication identity (for example, paging-RNTI) of the terminal may be masked to the CRC.

That is, the terminal monitors the PDCCH based on the P-RNTI in a subframe belonging to its own paging occasion 11012. When the PDCCH masked with the P-RNTI is detected, the terminal decodes the DCI transmitted on the PDCCH. This DCI indicates the PDSCH resource to which the paging message is transmitted to the terminal. The terminal decodes the RRC paging message from the PDSCH resource indicated by the DCI.

The paging cycle 11013 may be determined cell-specifically and may also be UE-specifically determined. In addition, a paging occasion 11012 is determined for each terminal based on its paging cycle 11013 and its own identity (for example, IMSI). Therefore, the paging message is not transmitted to all terminals at possible paging occasion 11011 at the base station, but the paging message is transmitted according to the paging occasion of the corresponding terminal. The paging timing will be described later in more detail.

The paging procedure may be used for not only receiving a mobile terminated (MT) call from each terminal, but also for changing system information, receiving a cell broadcast message (that is, receiving an ETWS/CAMS alert message), or informing the EAB of a change.

Any one of the paging records included in the RRC paging message includes a UE identity (for example, IMSI or S-TMSI) (that is, when the paging procedure is used for MT call purposes),. In the RRC_IDLE mode, and the UE, which is in the RRC_IDLE mode, initiates a random access procedure to establish an RRC connection with the network (for example, to transmit a service request).

In addition, when the systemInfoModification is included in the RRC paging message, the terminal reacquires the required system information using a system information acquisition procedure.

In addition, when the etws-Indication is included in the RRC paging message and the terminal supports ETWS, the terminal immediately reacquires SIB 1. That is, the terminal does not wait until the next system information change period boundary. If the schedulingInfoList included in SIB 1 indicates that SIB 10 exists, the terminal acquires SIB 10 based on the schedulingInfor. In addition, if the schedulingInfoList included in SIB 1 indicates that SIB 11 exists, the terminal acquires SIB 11 based on the schedulingInfor.

In addition, when the cmas-Indication is included in the RRC paging message and the terminal supports CMAS, the terminal immediately reacquires SIB 1. That is, the terminal does not wait until the next system information change period boundary. If the schedulingInfoList included in SIB 1 indicates that SIB 12 exists, the terminal acquires SIB 12 based on the schedulingInfor.

As described above, when the RRC paging message includes a cell broadcast message (that is, ETWS/CAMS message) indication, the terminal receives SIB 10, SIB 11, and SIB 12 with reference to the schedulingInfoList of the SIB 1. The received SIB 10, SIB 11, and SIB 12 is delivered to the upper layer (for example, RRC layer) In the upper layer of the terminal, if a message identifier belonging to the cell broadcast message transmitted through SIB 10, SIB 11, and SIB 12 is included in the search list of the terminal, the message is displayed on the terminal, and otherwise is discarded.

In addition, when the terminal, which is in an RRC_IDLE mode, supports EAB and the an eab-ParamModification field is included in the RRC paging message, the terminal considers that previously stored SIB 14 is not valid and immediately reacquires SIB 1. That is, the terminal does not wait until the next system information change period boundary. The terminal reacquires SIB 14 using a system information acquisition procedure.

Discontinuous Reception for Paging

The UE may use discontinuous reception (DRX) in idle mode to reduce power consumption.

One paging occasion (PO) is a sub-frame for the NB-IoT on the NPDCCH that has a P-RNTI transmitted on the PDCCH or the MPDCCH or addresses a paging message.

In the P-RNTI transmitted in the MPDCCH case, PO refers to a start subframe of the MPDCCH repetition.

In the case of the P-RNTI transmitted on the NPDCCH, PO indicates the start subframe of NPDCCH repetition.

However, if the subframe determined by the PO is not a valid NB-IoT downlink subframe, a first valid NB-IoT downlink subframe after the PO indicates a start subframe in which the NPDCCH is repeated.

One paging frame PF is one radio frame that may include one or multiple paging opportunities.

When DRX is used, the UE only needs to monitor one PO per DRX cycle.

One paging narrowband (PNB) is one narrowband in which the UE performs paging message reception.

PF, PO and PNB are determined by Equation 1 below using the DRX parameters provided in the system information

SFN mod T=(T div N)*(UE_ID mod N) [Equation 1]

The index i_s indicating PO in the subframe pattern may be obtained from Equation 2 below.

i_s=floor(UE_ID/N) mod Ns

If the P-RNTI is monitored on the MPDCCH, the PNB may be determined by Equation 3 below.

PNB=floor (UE_ID/(N*Ns)) mod Nn [Equation 3]

When the P-RNTI is monitored on the NPDCCH, the UE supports paging on a non-anchor carrier, and a paging configuration for the non-anchor carrier is provided by system information, the paging carrier is determined by a minimum paging carrier n that satisfies Equation 4 below.

floor(UE_ID/(N*Ns)) mod Σⱼ₌₀^{J-(maxPagingCarriers-1)}Weight[j]<Σₖ₌₀^{k-(n-1)}Weight[k] [Equation 4 4]

The system information DRX parameters stored in the UE are locally updated at the UE whenever the DRX parameter values change in the SI.

If the UE does not have an IMSI, for example, when the UE makes an emergency call without USIM, the UE uses UE_ID=0 as the default identity in the above formulas PF, i_s and PNB.

The following parameters are used for the calculation of PF, i_s, PNB and NB-IoT paging carrier.

T: DRX cycle of UE. Except for NB-IoT, the UE-specific extended DRX value of 512 radio frames is configured by the upper layer with T=512.

Otherwise, T is determined to be the shortest of the UE-specific DRX values when allocated by the upper layer, and the default DRX values are broadcast in the system information.

If the UE-specific DRX is not configured by the higher layer, the default value applies.

The UE-specific DRX does not apply to NB-IoT.

NB: T/512 and T/1024 for 4T, 2T, T, T/2, T/4, T/8, T/16, T/32, T/64, T/128 and T/512 and T/1024.

N: min (T, nB)

Ns: max (1, nB/T)

Nn: the number of paging narrowbands provided in the system information

UE_ID:

When IMSI mod 1024, P-RNTI is monitored on the PDCCH.

When IMSI mod 4096, P-RNTI is monitored on the PDCCH.

When IMSI mod 16384, P-RNTI is monitored on MPDCCH or P-RNTI is monitored on NPDCCH, and UE supports paging on the non-anchor carrier and the paging configuration for the non-anchor carrier is provided in the system information.
maxPagingCarriers: The number of configured paging carriers provided in the system information.

weight (i): Weight for NB-IoT paging carrier i.

IMSI is given as a sequence of integers (0.9).

In the above equation, IMSI should be interpreted as a decimal number, and the first number given in the sequence represents the most significant number.

For example, in IMSI=12 (digit1=1, digit2=2), this is interpreted as decimal “12” instead of “1×16+2=18”.

Subframe Patterns

<FDD>

If P-RNTI is transmitted on PDCCH or NPDCCH, the P-RNTI is transmitted on the MPDCCH with system bandwidth >3 MHz:

TABLE 15

| | PO when | PO when | PO when | PO when |
|---|---|---|---|---|
| Ns | i_s = 0 | i_s = 1 | i_s = 2 | i_s = 3 |
| 1 | 9 | N/A | N/A | N/A |
| 2 | 4 | 9 | N/A | N/A |
| 4 | 0 | 4 | 5 | 9 |

If the P-RNTI is transmitted on the MPDCCH with a system bandwidth of 1.4 MHz and 3 MHz:

TABLE 16

| | PO when | PO when | PO when | PO when |
|---|---|---|---|---|
| Ns | i_s = 0 | i_s = 1 | i_s = 2 | i_s = 3 |
| 1 | 5 | N/A | N/A | N/A |
| 2 | 5 | 5 | N/A | N/A |
| 4 | 5 | 5 | 5 | 5 |

<TDD (All UL/DL Configuration)>

If the P-RNTI is transmitted on PDCCH or the P-RNTI is transmitted on the MPDCCH with system bandwidth >3 MHz:

TABLE 17

| | PO when | PO when | PO when | PO when |
|---|---|---|---|---|
| Ns | i_s = 0 | i_s = 1 | i_s = 2 | i_s = 3 |
| 1 | 0 | N/A | N/A | N/A |
| 2 | 0 | 5 | N/A | N/A |
| 4 | 0 | 1 | 5 | 6 |

If the P-RNTI is transmitted on the MPDCCH with a system bandwidth of 1.4 MHz and 3 MHz:

TABLE 18

| | PO when | PO when | PO when | PO when |
|---|---|---|---|---|
| Ns | i_s = 0 | i_s = 1 | i_s = 2 | i_s = 3 |
| 1 | 1 | N/A | N/A | N/A |
| 2 | 1 | 6 | N/A | N/A |
| 4 | 1 | 1 | 6 | 6 |

FIG. 12 is a diagram illustrating an initial UE message procedure to which the present invention can be applied.

When the eNB receives, on the air interface, a first UL NAS message transmitted for forwarding to the MME through the RRC connection, the eNB invokes the NAS transmission procedure and transmits an INITIAL UE message containing the NAS message to the MME as a NAS-PDU IE.

The eNB allocates a unique eNB UE S1AP ID to be used for the UE and includes the allocated eNB UE S1AP ID in the INITIAL UE message.

In the case of the network sharing, the selected PLMN is indicated by the PLMN Identity IE in the TAI IE included in the INITIAL UE message.

When the eNB receives the S-TMSI IE from the air interface, the eNB includes the received S-TMSI IE in the INITIAL UE message. If the eNB does not support NNSF and the eNB receives the GUMMEI IE from the air interface, the eNB may include the received GUMMEI IE in the INITIAL UE message.

If the eNB does not support NNSF and the eNB receives the GUMMEI Type IE from the air interface, the eNB may include the received GUMMEI Type IE in the INITIAL UE message.

If the configuration of the UE-associated logical S1-connection toward the CN is performed due to the RRC connection setup initiated from the CSG cell, the CSG_Id is included in the INITIAL UE message.

When the UE-associated logical S1-connection is configured for the CN due to the RRC connection setup initiated from the hybrid cell, the CSG Id IE and the cell access mode IE are included in the INITIAL UE message.

When the UE-associated logical S1-connection is configured for the CN due to the RRC connection setup triggered by a relay Node, the GW transport layer address IE and the relay node indicator IE may be included in the INITIAL UE message (see TS 36.300).

If the eNB has an L-GW function for an LIPA operation, the eNB includes the GW Transport Layer Address IE in the INITIAL UE message.

If the SIPTO L-GW Transport Layer Address IE is received in an INITIAL UE message, when the MME supports it, the MME may use the SIPTO L-GW Transport Layer Address IE for as SIPTO@LN operation as specified in 3GPP TS 23.401 [11].

If the LHN ID IE is included in the INITIAL UE message, when the MME supports it, the MME may use the LHN ID IE as specified in 3GPP TS 23.401 [11].

If the Tunnel Information for BBF IE is received in the INITIAL UE message, when the MME supports it, the MME uses Tunnel Information for BBF IE in the core network as specified in 3GPP TS 23.139 [37].

If the MME Group ID IE is included in the INITIAL UE message, this indicates that the message is a redirected message and, when the MME supports it, the MME uses the MME Group ID IE as specified in 3GPP TS 23.401 [11].

If the UE Usage Type IE is included in the INITIAL UE message, when the MME supports it, the MME selected in the DCN uses the UE Usage Type IE as specified in 3GPP TS 23.401 [48].

Table 19 below shows an example of an IE configuring an INITIAL UE message.

TABLE 19

| | | | IE type | | | |
|---|---|---|---|---|---|---|
| IE/Group | | | and | | | Assigned |
| Name | Presence | Range | reference | Semantics description | Criticality | Criticality |
| Message | M | | 9.2.1.1 | | YES | ignore |
| Type | | | | | | |
| eNB UE | M | | 9.2.3.4 | | YES | reject |
| S1AP ID | | | | | | |
| NAS-PDU | M | | 9.2.3.5 | | YES | reject |
| TAI | M | | 9.2.3.16 | Indicating the Tracking | YES | reject |
| | | | | Area from which the UE | | |
| | | | | has sent the NAS message. | | |
| E-UTRAN | M | | 9.2.1.38 | Indicating the E-UTRAN | YES | ignore |
| CGI | | | | CGI from which the UE | | |
| | | | | has sent the NAS message. | | |
| RRC | M | | 9.2.1.3a | | YES | ignore |
| Establishment | | | | | | |
| Cause | | | | | | |
| S-TMSI | O | | 9.2.3.6 | | YES | reject |
| CSG Id | O | | 9.2.1.62 | | YES | reject |
| GUMMEI | O | | 9.2.3.9 | | YES | reject |
| Cell Access | O | | 9.2.1.74 | | YES | reject |
| Mode | | | | | | |
| GW | O | | Transport | Indicating GW Transport | YES | ignore |
| Transport | | | Layer | Layer Address if the GW | | |
| Layer | | | Address | is collocated with eNB. | | |
| Address | | | 9.2.2.1 | | | |
| Relay Node | O | | 9.2.1.79 | Indicating a Relay node. | YES | reject |
| Indicator | | | | | | |
| GUMMEI | O | | ENUMERATED | | YES | ignore |
| Type | | | (native, | | | |
| | | | mapped, | | | |
| | | | . . . ) | | | |
| Tunnel | O | | Tunnel | Indicating HeNB's Local | YES | ignore |
| Information | | | Information | IP Address assigned by the | | |
| for BBF | | | 9.2.2.3 | broadband access provider, | | |
| | | | | UDP port Number. | | |
| SIPTO L- | O | | Transport | Indicating SIPTO L-GW | YES | ignore |
| GW | | | Layer | Transport Layer Address if | | |
| Transport | | | Address | the SIPTO L-GW is | | |
| Layer | | | 9.2.2.1 | collocated with eNB. | | |
| Address | | | | | | |
| LHN ID | O | | 9.2.1.92 | | YES | ignore |
| MME | O | | 9.2.3.44 | | YES | ignore |
| Group ID | | | | | | |
| UE Usage | O | | INTEGER | | YES | ignore |
| Type | | | (0 . . . 255) | | | |
| CE-mode-B | O | | 9.2.1.118 | | YES | ignore |
| Support | | | | | | |
| Indicator | | | | | | |

The reason why the remote UE reporting procedure described with reference to FIGS. 7 and 8 is performed is to recognize the presence of the remote UE in order to perform a lawful interception (LI) in the network.

In the UE-to-Network Relay of Rel-13, the UE context of the remote UE does not exist in the network, and the remote UE is a layer 3 relay architecture that receives service through some PDN connections of the UE-to-Network Relay.

Rel-13's remote UE reporting procedure has the following features.

1) As shown in FIG. 7, the reporting procedure is performed immediately after the PC5 link is established after IP allocation.

2) relay UE is performed in the EMM-CONNECTED state.

3) 1) assumes that in Rel-13, if data to be transmitted by the remote UE through the Uu interface (network) or signaling is generated, the remote UE directly transmits the data when discovering the UE-to-Network Relay and establishing a PC5 link with the relay.

To this end, in step 1) of FIG. 7, the relay UE switches to EMM-CONNECTED to perform an operation for transmitting data of the remote UE.

However, in Rel-15, it is assumed that the remote UE can discover the relay UE or establish the PC5 link regardless of data transmission.

That is, the relay UE may not need to switch to EMM-CONNECTED.

However, the Rel-13's remote UE reporting procedure is designed on the assumption that the relay UE operates in the EMM-CONNECTED state. For this reason, when the previous reporting procedure is used, there is a problem in that the UE needs to switch to the EMM-CONNECTED mode unnecessarily when being in the EMM-IDLE mode.

In this layer 3 relay architecture, there is a problem that the network cannot recognize the presence of the remote UE.

In the case of the Rel-15, unlike the Rel-13's UE-to-Network Relay concept, since the layer 2 relay architecture is assumed, the UE context of the remote UE exists in the network, and the network may recognize the remote UE without any additional procedure.

Therefore, the remote UE reporting procedure for the LI purpose of the Rel-13 is not necessary, and for efficient handling (for example, signaling, etc.) not for the LI purpose, the network needs to recognize whether the PC5 link is established between the remote UE and the UE-to-Network relay UE.

For example, if the network (for example, MME or eNB, etc.) recognizes that the remote UE has established the PC5 link with the UE-to-Network relay UE, the network may transmit and receive the signaling or the data with the remote UE through the indirect path).

That is, when the network recognizes that the PC5 link is established between the remote UE and the relay UE, the network and the remote UE may transmit or receive signaling or data through the PC5 link of the relay UE.

However, if the network does not recognize that the PC5 link is established between the remote UE and the relay UE, there is a problem in that unnecessary signaling or power consumption of the remote UE may occur because it is not known whether the indirect path is available.

Accordingly, the present invention proposes a method for a relay UE to report a connection state between a remote UE and a relay UE so that the network can recognize whether the link is formed between the remote UE and the relay UE.

In addition, it proposes a method for a relay UE to perform a reporting procedure in an EMM-IDLE mode instead of an EMM-CONNECTED.

Hereinafter, in the present invention, a state in which the remote UE establishes the PC5 link with the UE-to-Network Relay or establishes a non-3GPP access link is called ‘linked’.

In addition, in the present invention, the UE-to-Network relay UE and the relay UE may be used in the same sense, and the present invention will be described based on PC5, but may also be applied to the use of a non-3GPP access link in a sidelink interval.

In the present invention, it is assumed that the remote UE and the relay UE have a (pre-) association as follows (see 3GPP TR 23.733).

Fast connection setup between erelay-UE and eRemote-UE is part of the service requirements and pairing may be used as a means for fast connection setup.

The following points can be considered for the fast connection setup.

Whether and how to improve connection settings with or without pre-connection

whether an association between eRemote-UE and erelay-UE is provided via EPC.

Whether the previous association is used only with private relay networks, i.e. networks configured in a certain trust relationship (for example, smartphone and smartwatch of the same owner or UE group belonging to the same company).

Hereinafter, in the present invention, it is assumed that the serving network entity of the remote UE is eNB_1 and the serving network entity of the relay UE is eNB_2.

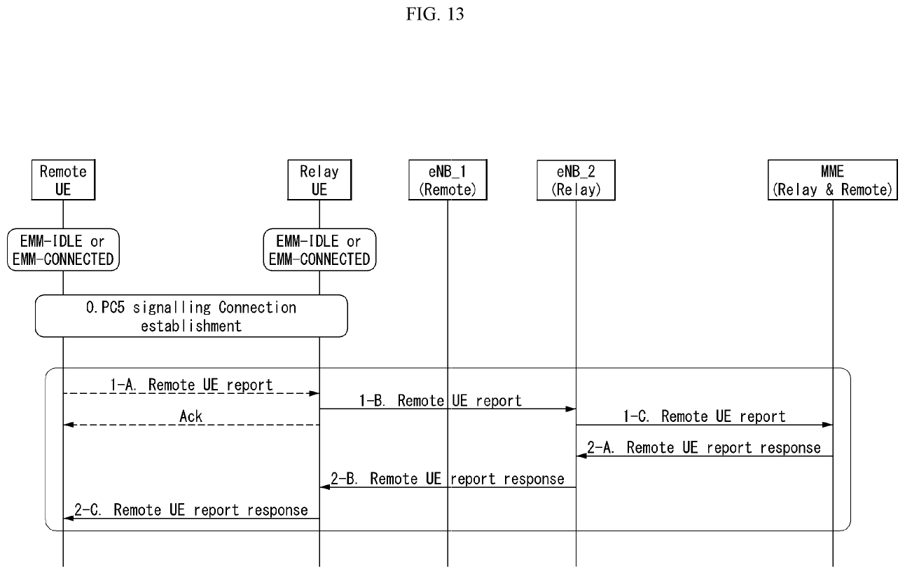

FIG. 13 is a diagram illustrating a remote UE report procedure according to an embodiment of the present invention.

Referring to FIG. 13, when the MME of the relay UE and the MME of the remote UE are the same, the relay UE may report to the MME through the reporting procedure that the link is established between the relay UE and the remote UE.

Specifically, 1. In step 0), if a PC5 direct link is established between the remote UE and the relay UE, the relay UE transmits the remote UE report message to the MME in order to report the MME that the PC5 direct link is established between the relay UE and the remote UE through eNB 2.

The step of starting the transmission of the message may vary depending on which of the remote UE or the relay UE generates and triggers the remote UE report message.

Step 1-A) indicates a case in which the remote UE triggers the remote UE report message, and step 1-B) indicates a case in which the relay UE triggers the remote UE report message.

1-A. The remote UE may generate the remote UE report message to initiate a reporting procedure and transmit the generated message to the relay UE through the established PC5 link.

At this time, the remote UE may receive an Ack for the remote UE report message from the relay UE.

i. In Step 1-A), the remote UE report message may use a new NAS message or a TAU request message used in an existing tracking procedure.

1-B. The relay UE transmits the remote UE report message to eNB_2.

i. In step 1-A), when the remote UE generates and transmits the remote UE report message, the relay UE forwards the remote UE report message received from the remote UE to eNB_2.

ii. Step 1-A), when the remote UE does not generate and transmit the remote UE report message, the relay UE generates the remote UE report message and transmits the generated remote UE report message to the eNB_2.

iii. In Step 1-B), the remote UE report message may use a new NAS message or a TAU request message used in the existing tracking procedure.

In this case, the relay UE may encapsulate the remote UE report message into the RRC message and include the S-TMSI of the remote UE and/or the GUMMEI of the remote UE in the RRC message.

1-C. The eNB_2 transmits the RRC message received in Step 1-B) to the MME based on the S-TMSI and/or the GUMMEI included in the RRC message. The MME may recognize the link status of the corresponding remote UE through the RRC message transmitted from the eNB_2.

2. The MME transmits the remote UE report response message (or link status report response message) to the remote UE as a response to the RRC message.

2-A. The MME transmits the remote UE report response message to the eNB_2.

i. When both the remote UE and the relay UE are EMM-CONNECTED, the eNB_2 performs an operation for creating the relationship between the remote UE and the relay UE.

The eNB_2 generates a local identifier of the remote UE and transmits the generated local identifier to the relay UE through step 2-B) or a separate RRC message.

The eNB_2 releases and/or deletes the DRB of the remote UE and generates an SLRB corresponding to the released and/or deleted DRB. Thereafter, the eNB_2 performs a procedure of mapping the generated SLRB to the DRB of the relay UE. At this time, when the eNB_2 determines that the existing DRB of the relay UE is not sufficient to transmit and receive the traffic of the remote UE, the eNB_2 may perform an operation of establishing an additional DRB of the relay UE.

2-B. The eNB 2 encapsulates a remote UE report response message transmitted from the MME into an RRC message and transmits the capsulated RRC message to the relay UE.

C. The relay UE transmits the remote UE report response message transmitted from the eNB 2 to the remote UE through the link between the relay UE and the remote UE.

i. The operation of step 2-C) may be performed regardless of whether step 2-A) is performed.

ii. The remote UE that receives the remote UE report response message from the relay UE stops the Uu interface monitoring. For example, the remote UE does not perform paging and/or SIB monitoring.

In another embodiment of the present invention, the remote UE may cause the paging monitoring through the Uu interface to stop early.

In this case, the remote UE can early stop the paging monitoring through the Uu interface, thereby reducing the power consumption of the remote UE.

Specifically, 1. At the point described below, the remote UE stops the Uu interface monitoring operation in step 0).

A. The moment that the link with the relay UE is established in Step 0)

B. The moment that ack for Step 1-A) is received from the relay UE

i. In this case, the relay UE may transmit, to the remote UE, ack indicating that the UE has successfully received the remote UE report message in step 1-A). In this case, step 2-C) may not be performed.

2. The relay UE may perform an operation of receiving an additional paging message for the remote UE at the point described below.

If the relay UE knows the paging occasion of the remote UE, the relay UE may additionally receive a paging message in addition to the paging occasion of the remote UE.

The relay UE transmits the received paging message to the remote UE through the sidelink or the PC5 link if the received paging message includes the identity of the remote UE. .

A. The moment that the link with the remote UE is established in Step 0)

B. The moment that the ack for Step 1-A) is transmitted to the remote UE or the remote UE report message is received in Step 1-A).

3. When the relay UE performs step 2-B) or step 2-C), the relay UE may not perform an operation of receiving the paging message at the paging occasion of the remote UE.

By the method, the relay UE may perform a reporting procedure for reporting the link status with the remote UE to the MME not only in the EMM-CONNECTED mode but also in the EMM-IDLE mode, and the MME may recognize whether the link is established between the remote UE and the relay UE.

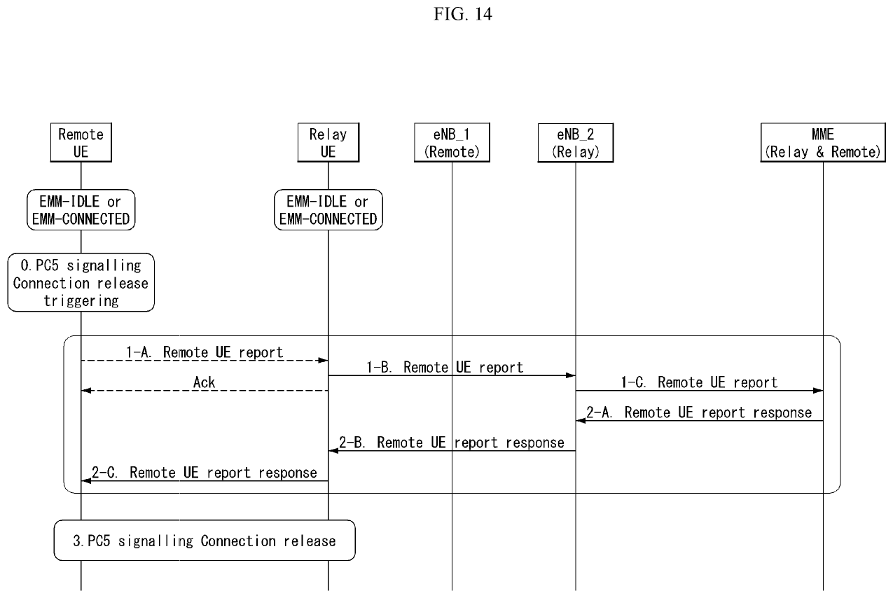

FIG. 14 is a diagram illustrating a remote UE report procedure according to an embodiment of the present invention.

Referring to FIG. 14, when the MME of the relay UE and the MME of the remote UE are the same, the relay UE may report the MME that the link between the relay UE and the remote UE is released through the reporting procedure.

Specifically, 1. When the release of the PC5 direct link between the remote UE and the relay UE is triggered in Step 0), the relay UE transmits the remote UE report message to the MME to inform the MME that the link with the remote UE has been released.

The step of starting the transmission of the message may vary depending on which of the remote UE or the relay UE generates and triggers the remote UE report message.

Step 1-A) indicates a case in which the remote UE triggers the remote UE report message, and step 1-B) indicates a case in which the relay UE triggers the remote UE report message.

1-A. The remote UE may generate the remote UE report message to initiate a reporting procedure and transmit the generated message to the relay UE through the established PC5 link.

At this time, the remote UE may receive an Ack for the remote UE report message from the relay UE.

i. In Step 1-A), the remote UE report message may use a new NAS message or a TAU request message used in an existing tracking procedure.

1-B. The relay UE transmits the remote UE report message to the eNB_2.

i. In step 1-A), when the remote UE generates and transmits the remote UE report message, the relay UE forwards the remote UE report message received from the remote UE to eNB_2.

ii. If the remote UE does not generate and transmit the remote UE report message in step 1-A), in step 1-A), the remote UE transmits, to the relay UE, an indication or message requesting the release of the PC5 link established between the relay UEs through the PC5 link.

The relay UE that receives an indication or message requesting the release of the PC5 link from the remote UE generates a remote UE report message and transmits the generated remote UE report message to the eNB_2.

iii. In Step 1-B), the remote UE report message may use a new NAS message or a TAU request message used in the existing tracking procedure.

In this case, the relay UE may encapsulate the remote UE report message into the RRC message and include the S-TMSI of the remote UE and/or the GUMMEI of the remote UE in the RRC message.

1-C. The eNB 2 transmits the RRC message received in Step 1-B) to the MME based on the S-TMSI and/or the GUMMEI included in the RRC message. The MME may recognize that the link of the corresponding remote UE is released through the RRC message transmitted from the eNB_2.

2. The MME transmits the remote UE report response message (or link status report response message) to the remote UE as a response to the RRC message.

2-A. The MME transmits the remote UE report response message to the eNB_2.

i. When both the remote UE and the relay UE are EMM-CONNECTED, the MME may perform an S1 release procedure of the remote UE.

ii. The eNB_2 receiving the remote UE report response message from the MME performs an operation for removing/deleting the relationship between the remote UE and the relay UE.

The eNB_2 deletes the context (for example, local identifier and the like) of the remote UE and deletes DRB mapping or multiplexing information related to traffic transmission of the remote UE.

The eNB_2 may release the DRB of the relay UE used to transmit and receive traffic of the remote UE.

The eNB_2 may delete SLRB of the remote UE and delete the configuration in which the deleted SLRB was mapped to the DRB of the relay UE.

2-B. The eNB_2 transmits the remote UE report response message to the relay UE.

2-C. The relay UE transmits the remote UE report response message to the remote UE.

i. The operation of step 1-C) may be performed regardless of whether step 2-A) is performed.

ii. The remote UE that receives the remote UE report response message from the relay UE starts the Uu interface monitoring. For example, the remote UE may perform a paging monitoring operation.

In another embodiment of the present invention, the relay UE may quickly release the PC5 link with the remote UE and switch to the Uu interface. This ensures stable reception of the paging message through the Uu interface even if the channel conditions of the sidelinks get worse.

1. In this case, the remote UE starts Uu interface monitoring at the following points.

A. The moment that ack for Step 1-A) is received from the relay UE

i. In this case, the relay UE may transmit, to the remote UE, ack indicating that the UE has successfully received the remote UE report message in step 1-A).

ii. The remote UE receiving the Ack from the relay UE performs a direct link release procedure to release the PC5 link. In this case, step 2-C) may not be performed.

B. The moment that the channel quality of the sidelink or the PC5 link between the relay and the remote UE deteriorates below a certain quality.

C. The moment that another relay UE is (re)selected.

This procedure is a procedure of the case of explicitly releasing the link between the remote UE and the relay UE.

However, when performing a procedure for implicitly releasing the link between the remote UE and the relay UE (for example, locally release and the like), the remote UE and the relay UE may perform the following operations.

1. Operation of Remote UE

A. After establishing the PC5 link with the relay UE, the remote UE starts or restarts the timer Tabcd with a given value when receiving signaling or data from the relay UE through the established PC5 link.

i. The timer may be a T4102 used in a direct link keepalive procedure or a new timer.

B. If the timer has expired, the remote UE starts the Uu interface monitoring.

2. Operation of relay UE

A. When a relay UE implicitly performs a procedure for releasing a link, the relay UE sends a remote UE reporting message to the MME to inform the MME that it is not linked with the corresponding remote UE.

B. When the relay UE is EMM-CONNECTED, the MME informs the eNB, in which the relay UE is camped on, that the relay UE and the remote UE are no longer linked.

The S IAP message for informing the eNB that the link between the relay UE and the remote UE is released includes an identity (for example, IMSI, S-TMSI, local identifier or the like) of the remote UE.

The eNB receiving the S IAP message from the MME recognizes that the corresponding remote UE and the relay UE are not in a linked state, deletes the context (for example, local identifier) of the corresponding remote UE, and releases the DRB associated with the traffic of the corresponding remote UE.

Hereinafter, the remote UE report message and the remote UE response message used in the present invention will be described.

The remote UE reporting procedure (or link status reporting procedure) described in the present invention may have the following features.

1. The remote UE reporting procedure may be performed separately or through a TAU procedure.

2. The remote UE reporting procedure may be performed in not only the EMM-IDLE mode but also the EMM-CONNECTED mode.

When the remote UE triggers the remote UE reporting procedure, the remote UE report message may include an IE as shown in Table 20 below (see 3GPP TS 24.301).

TABLE 20

| IEI | Information Element | Type/Reference | Presence | Format | Length |
|---|---|---|---|---|---|
| | Protocol discriminator | Protocol discriminator | M | V | ½ |
| | | 9.2 | | | |
| | Security header type | Security header type | M | V | ½ |
| | | 9.3.1 | | | |
| | message identity | Message type | M | V | 1 |
| | | 9.8 | | | |
| | EPS update type | EPS update type | M | V | ½ |
| | | 9.9.3.14 | | | |
| | NAS key set identifier | NAS key set identifier | M | V | ½ |
| | | 9.9.3.21 | | | |
| | Old GUTI | EPS mobile identity | M | LV | 12 |
| | | 9.9.3.12 | | | |

Protocol discriminator: Used to distinguish a message for user-network call control from other messages.

Security header type: The security header type IE includes control information related to security protection of a NAS message.

EPS update type: EPS update IE is used to specify an area with which the update procedure is associated.

In Table 20, when the remote UE reporting procedure is separately performed, the message identity may use an identity for identifying the remote UE reporting procedure (or link status reporting procedure).

However, when the remote UE reporting procedure is performed through the TAU procedure, an identity indicating a tracking area update request may be used as the message identity (see 3GPP TS 24.301 subcluase 9.2).

At this time, the remote UE report message may include an identity indicating whether the link is established between the relay UE and the remote (that is, whether the link is established) and an identity for identifying the associated relay UE.

Table 21 below shows an example of an identity for identifying the relay UE included in the remote UE report message

TABLE 21

| | | | | |
|---|---|---|---|---|
| Linked Relay GUTI | EPS mobile identity | O | LV | 12 |
| | 9.9.3.12 | | | |

When the remote UE informs the linked state with the relay UE, the remote UE may include and transmit the identity of the relay UE in the remote UE report message as shown in Table 21.

When the MME receives the remote UE report message including the identity of the relay UE, the MME may recognize that the remote UE has established the link with the relay UE based on the identity of the relay UE included in the remote UE report message.

In addition, the remote UE report message may further include not only the identity of the relay UE of Table 21, but also an identity indicating whether the remote UE forms the link with the relay UE.

In order for the relay UE to trigger the remote UE reporting procedure in the EMM-CONNECTED mode or the EMM-IDLE mode, the remote UE report message may include IE as shown in Table 22 below (see 3GPP TS 24.301)

TABLE 22

| IEI | Information Element | Type/Reference | Presence | Format | Length |
|---|---|---|---|---|---|
| | Protocol discriminator | Protocol discriminator | M | V | ½ |
| | | 9.2 | | | |
| | Security header type | Security header type | M | V | ½ |
| | | 9.3.1 | | | |
| | message identity | Message type | M | V | 1 |
| | | 9.8 | | | |
| | EPS update type | EPS update type | M | V | ½ |
| | | 9.9.3.14 | | | |
| | NAS key set identifier | NAS key set identifier | M | V | ½ |
| | | 9.9.3.21 | | | |
| | Old GUTI | EPS mobile identity | M | LV | 12 |
| | | 9.9.3.12 | | | |

The definition of each IE in Table 22 is as shown in Table 20.

In Table 22, when the remote UE reporting procedure is separately performed, the message identity may use an identity for identifying the remote UE reporting procedure (or link status reporting procedure).

However, when the remote UE reporting procedure is performed through the TAU procedure, an identity indicating a tracking area update request may be used as the message identity (see 3GPP TS 24.301 subcluase 9.2).

In this case, even when the relay UE triggers the remote UE reporting procedure, as described above, the remote UE report message may identify an identifier indicating whether the relay UE and the Remote are linked (that is, whether a link is established) and the identity for identifying the associated relay UE.

Table 23 below shows an example of an identity for identifying the relay UE included in the remote UE report message

TABLE 23

| IEI | Information Element | Type/Reference | Presence | Format | Length |
|---|---|---|---|---|---|
| 79 | Remote UE Context | Remote UE | O | TLV-E | 3-65538 |
| | Connected | context list IE | | | |
| | | 9.9.4.20 | | | |
| 7A | Remote UE Context | Remote UE | O | TLV-E | 3-65538 |
| | Disconnected | context list IE | | | |
| | | 9.9.4.20 | | | |

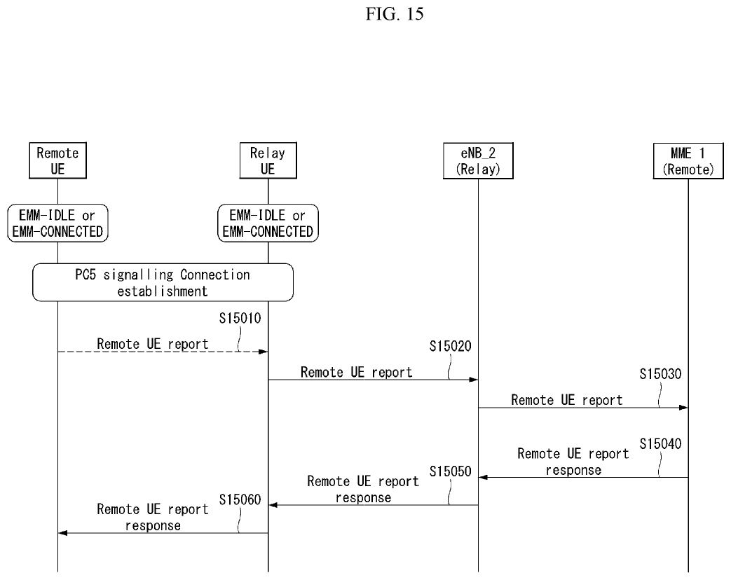

FIG. 15 is a diagram illustrating a message flow of a relay UE for a remote UE report procedure according to an embodiment of the present invention.

Referring to FIG. 15, when the MME of the relay UE and the MME of the remote UE are the same or different, the relay UE may report the MME of the remote UE that the link between the relay UE and the remote UE is released through the reporting procedure.

Hereinafter, in the present invention, the serving network entity of the remote UE is called eNB_1 and MME_1, and the serving network entity of the relay UE is called eNB2, MME_2, and S-GW_2.

Specifically, if the PC5 direct link is established between the remote UE and the relay UE in the EMM-IDLE mode or the EMM-CONNECTED mode, the relay UE transmits the remote UE report message (or, report message) to MME_1 through the eNB 2 to report MME-1 or Remote that the PC5 direct link is established between the relay UE and the remote UE through the eNB 2 (S15020 and S15030).

When the remote UE triggers the remote UE reporting procedure, the remote UE report message is generated by the remote UE and transmitted to the relay UE (S15010).

At this time, the remote UE report message may include the IE described in Tables 20 and 21 above.

However, when the relay UE triggers the remote UE reporting procedure, the remote UE report message is generated by the relay UE.

In this case, the relay UE may transmit a request message requesting the S-TMSI of the remote UE or the GUMMEI of the MME_1 to the remote UE in order for the remote UE report message to be transmitted to the MME_1 by the eNB_2, and may receive a response message including the S-TMSI of the remote UE or the GUMMEI of the MME_1 in response thereto.

In addition, the S-TMSI of the remote UE or the GUMMEI of the MME_1 acquired from the remote UE may be included in the remote UE report message and transmitted.

Thereafter, the remote UE report response message is received from the MME_1 as a response to the remote UE report message through the eNB_2 (S150404 and S1050).

The remote UE report response message received from the MME_1 may be transmitted to the remote UE through the link established between the remote UE and the relay UE (S15060).

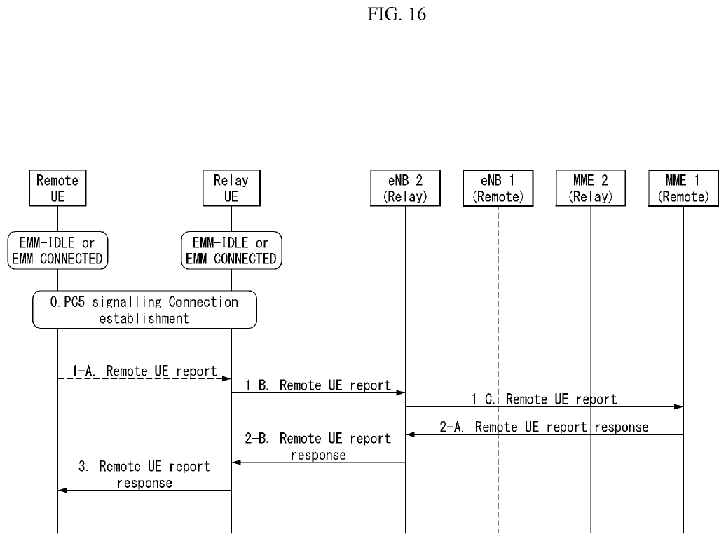

FIG. 16 is a diagram illustrating a remote UE report procedure according to an embodiment of the present invention.

Referring to FIG. 16, when the MME of the relay UE and the MME of the remote UE are different, the relay UE may report the MME of the remote UE that the link between the relay UE and the remote UE is released through the reporting procedure.

Specifically, 1. In step 0), if the PC5 direct link is established between the remote UE and the relay UE, the relay UE transmits the remote UE report message to the MME_1 through the eNB 2 in order to report the MME 1 managing the remote UE that the PC5 direct link is established between the relay UE and the remote UE.

In this case, the step of starting the transmission of the message may vary depending on which of the remote UE or the relay UE generates and triggers the remote UE report message.

Step 1-A) indicates a case in which the remote UE triggers the remote UE report message, and step 1-B) indicates a case in which the relay UE triggers the remote UE report message.

1-A. The remote UE may generate the remote UE report message to initiate a reporting procedure and transmit the generated message to the relay UE through the established PC5 link.

i. The remote UE generates a remote UE report message, which is a NAS message, and transmits, to lower layers (for example, AS layer or RRC layer), the S-TMSI of the remote UE or the GUMMEI of the MME_1 for routing the NAS messages to the MME_1 managing the remote UE instead of the MME_2 managing the relay UE (see 3GPP TS 24.301 subclause 5.3.1.1).

The RRC layer receiving the S-TMSI and/or GUMMEI encapsulates the NAS message into an RRC message, and includes the S-TMSI or GUMMEI in the encapsulated RRC message.

Thereafter, the remote UE transmits the RRC message including the S-TMSI or the GUMMEI to the relay UE through the established PC5 link.

ii. In step 1-A), a new NAS message or the TAU request message used in the existing tracking procedure may be used as the remote UE report message, and the remote UE report message may include the IE described in Table 20 and Table 21.

1-B. The relay UE transmits the remote UE report message to the eNB_2. At this time, the operation may vary depending on whether step 0) is performed.

i. When step 0) is performed, the relay UE transmits the RRC message received from the remote UE to the eNB_2.

ii. If Step 0) is not performed, the relay UE performs i) and ii) of step A) which are an operation performed by the remote UE in remote UE Step 1-A.

In this case, the Relay UE may acquire the S-TMSI of the remote UE and/or the GUMMEI of the MME_1 for routing the NAS message to the MME 1.

The relay UE may acquire the S-TMSI and/or the GUMMEI from the remote UE through step 1-A), transmit a request message requesting the S-TMSI and/or the GUMMEI to the remote UE, and acquire the S-TMSI and/or the GUMMEI by receiving the response message including the S-TMSI and/or the GUMMEI in response thereto.

In this case, the process of acquiring the S-TMSI and/or the GUMMEI by the relay UE may be performed before the relay UE transmits the RRC message to the eNB_2.

1-C. The eNB_2 transmits the RRC message received in Step 1-B) to the MME_1 based on the S-TMSI and/or the GUMMEI included in the RRC message. The MME_1 receiving the remote UE report message from the eNB_2 may recognize whether the link is established between the remote UE and the relay UE.

Using this method, when directly reporting whether the link is established between the remote UE and the relay UE to the MME_1 of the remote UE, compared to the case of reporting through the MME_2 of the relay UE, the MME_1 can recognize that the eNB of the remote UE has changed from eNB_1 to eNB_2 without additional signaling.

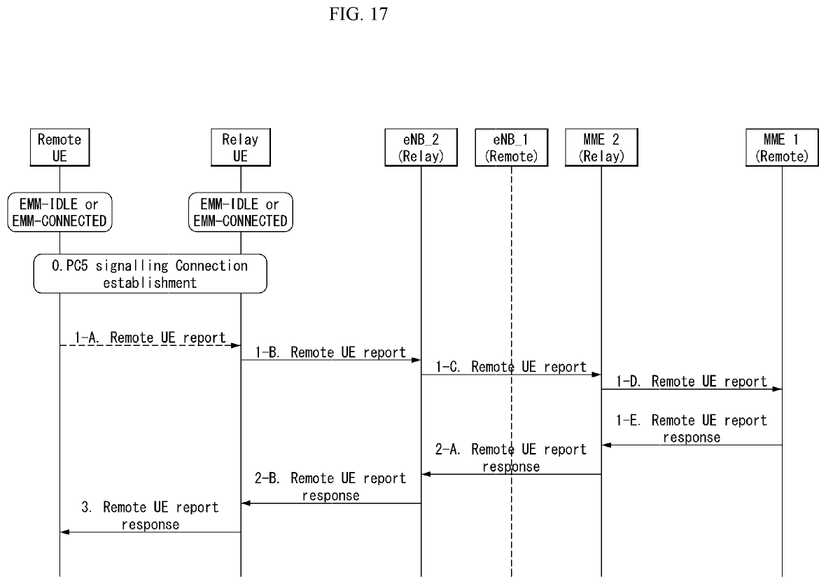

FIG. 17 is a diagram illustrating a remote UE report procedure according to an embodiment of the present invention.

Referring to FIG. 17, when the MME of the relay UE and the MME of the remote UE are different, the relay UE may report the MME of the remote UE that the link between the relay UE and the remote UE is released through the MEE of the relay UE.

Hereinafter, only portions that differ from the method described with reference to FIG. 16 will be described. It is the same as FIG. 16 except for the difference described below.

Specifically, unlike FIG. 16, in order for the eNB_2 to transmit the remote UE report message for the remote UE reporting procedure to the MME_2 that manages the relay UE, the remote UE report message may include S-TMSI and/or GUMMEI of MME_2 but not the S-TMSI and/or the GUMMEI of the MME_b 1.

The MME_2 receives the NAS message for reporting whether the link is established between the remote UE and the relay UE from the relay UE through the eNB_2.

1-D. The MME_2 checks the remote UEs linked with the relay UE included in the IE of the received NAS message and transmits the remote UE report message indicating that the corresponding remote UE has established a link with the relay UE to the MMES to which the linked remote UE belongs.

In this case, the remote UE report message transmitted from the MME_2 to the MME_1 may include each identity for identifying the relay UE and the remote UE linked to the relay UE.

1-E. Thereafter, the MME_2 receives the remote UE report response message as a response to the remote UE report message from the MME_1.

The MME_1 and the eNB_1 may perform the following operation to allocate a new S1AP ID.

i. In step 1-C), the eNB_2 may include the same number of eNB UE S1AP ID IEs as the number of remote UEs linked with the relay UE in the S1AP message transmitted to the MME 2.

That is, the eNB_2 may transmit an S1AP message including eNB S1AP ID IE of each remote UE linked with the relay UE to the MME 2.

ii. The MME_2 receiving the S1AP message from the eNB_2 is an MME managing each remote UE linked with the relay UE, and transmit eNB UE S1AP ID for identifying each remote UE by including the eNB UE S1AP ID in the remote UE report message when transmitting the remote UE report message in step 1-D).

iii The MME_1 receiving the remote UE report message from the MME_2 transmits the remote UE report response message to the MME_2 as a response to the remote UE report message in step 1-E).

In this case, the MME_1 may transmit the eNB UE S1AP ID included in the remote UE report message and MME UE S1AP ID newly allocated to the remote UE by the MME_1 to the MME 2 by including the eNB UE S1AP ID and the MME UE S1AP ID in the remote UE report response message.

iv. The MME_2 receiving the remote UE report response message from the MME_1 includes at least one of an eNB UE S1AP ID, an MME UE S1AP ID allocated by MME_1, an identity of MME_1, or an identity of a remote UE in step 2-A) in the remote UE report response message and transmits the same to the eNB_2.

v. The eNB that receives the remote UE report response message including at least one of an eNB UE S1AP ID, an MME UE S1AP ID allocated by MME_1, an identity of MME_1, or an identity of a remote UE from the MME 2 determines that an S1AP association (connection) is established between the corresponding remote UE and the MME 1.

vi. Thereafter, the MME_2 may directly transmit the DL message to the eNB_2.

vii. As such, an operation for allocating a new S1AP ID by the MME_1 and the eNBP_1 may be performed when both the relay UE and the remote UE are in the EMM-CONNECTED mode.

Although FIG. 16 and FIG. 17 illustrate a case in which the remote UE and the relay UE form the link, the present invention may be applied to a case in which the link formed between the remote UE and the relay UE is released.

In the case of reporting whether the link is established between the remote UE and the relay UE through the MME_2 of the relay UE by using this method, there is an effect of reducing the signaling overhead for reporting when one or more links are established or released as compared to the case of directly reporting to the MME_1 of the remote UE.

The MME recognizing whether the link is established between the remote UE and the relay UE through the method described with reference to FIGS. 13 to 17 may transmit a paging message to the remote UE when data for the remote UE is generated when the remote UE is in the EMM-IDLE mode.

Hereinafter, the paging procedure proposed by the present invention for paging of the remote UE will be described.

As described above, in the layer 3 relay architecture of Rel-13, there is no UE context for the remote UE in the network. Therefore, even if the downlink data for the remote UE is generated, the network considers the generated downlink data to be downlink data for the relay UE.

In this case, when the relay UE is in the EMM-IDLE mode, even if the downlink data for the remote UE are generated, the paging message is transmitted toward the relay UE, not the remote UE.

Unlike Rel-13's UE-to-Network Relay, Rel-15 recognizes a remote UE as an independent entity from a relay UE in the network.

That is, since the context exists in the remote UE in the network (that is, MME), EMM or ESM signaling for the remote UE occurs independently of the relay UE.

In this case, signaling for paging for the remote UE is also generated independently of the relay UE.

In this case, when the remote UE establishes the PC5 link with the relay UE and does not monitor its own paging for power saving, the relay UE must monitor its own paging occasion and the paging occasion of the remote UE together, so there is a problem that power consumption is increased.

Therefore, in order to solve this problem, when the MME recognizes whether the link is established between the remote UE and the relay UE, a method for reducing power consumption of a relay UE by transmitting a paging message of a remote UE to a relay UE at a paging occasion of the relay UE to reduce the number of times the relay UE monitors paging is proposed.

In addition, when the relay UE is the EMM-CONNECTED, a method for reducing paging for a remote UE is proposed.

In the paging method of the present invention, it is assumed that the network recognizes whether the link is established between the remote UE and the relay UE.

Hereinafter, in the present invention, the case where serving network entities (that is, MME and/or S-GW) of the relay UE and the remote UE are different will be assumed and described.

However, the present invention can be applied to the same case as well as the case where the serving network entity is different, and in this case, interaction between the MMES of each of the relay UE and the remote UE can be performed internally.

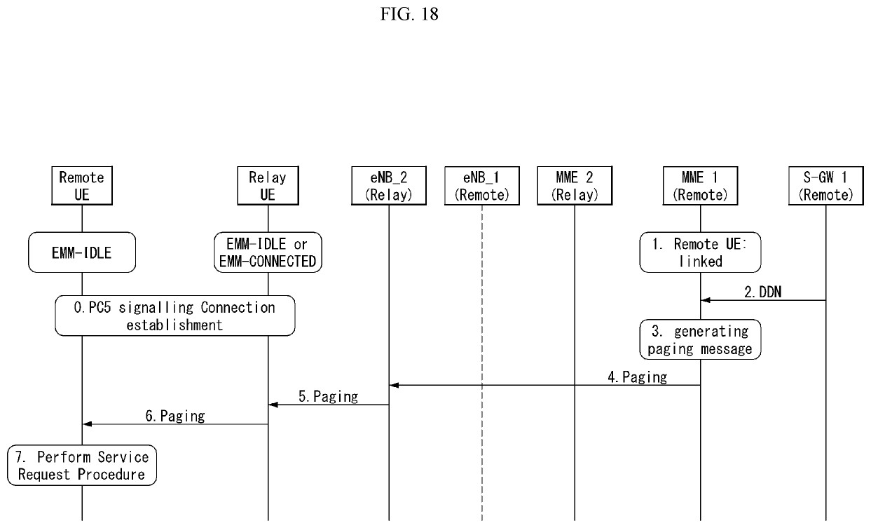

FIG. 18 is a diagram illustrating a paging procedure according to an embodiment of the present invention.

Referring to FIG. 18, the relay UE may receive the paging message for the remote UE from the MME of the remote UE at the paging occasion of the relay UE and transmit the paging message to the remote UE.

Specifically, 1. The MME_1 may recognize the linked state of the remote UE and the relay UE.

In this case, the MME_1 may recognize whether the link is established between the remote UE and the relay UE through the method described with reference to FIGS. 13 to 17.

2. When the remote UE is in the EMM-IDLE mode and the relay UE is in the EMM-IDLE mode or the EMM-CONNECTED mode, the MME_1 receives a downlink data notification message (DDN) for the remote UE.

3. When receiving the DDN for the remote UE, the MME_1 generates the paging message for paging the remote UE as described with reference to FIG. 11.

When the relay UE is in the EMM-IDLE mode, the S1AP paging message described with reference to FIG. 11 may be used. However, when the relay UE is in the EMM-CONNECTED mode, the S1AP paging message described with reference to FIG. 11 may be used or a new NAS paging message for paging the remote UE may be defined and used.

In this case, when the S1AP paging message described with reference to FIG. 11 is used, an operation different from the method described with reference to FIG. 11 may be performed as follows.

A. The CN Domain IE of the paging message is set based on the paging message of the remote UE. IEs other than the CN Domain IE are set based on the information of the relay UE when it is recognized that the remote UE is in the linked state.

i. For example, in step 1), MME_1 generates the UE Identity Index value of the paging message based on the identity of the relay UE, not based on the identity of the remote UE, and transmits the generated UE Identity Index value by including generated UE Identity Index value in the paging message.

The information on the UE Identity Index value is as described with reference to FIG. 7.

B. The paging message may include a specific IE indicating whether it is for a remote UE or for a relay UE.

At this time, the specific IE may include the following information.

i. The paging message may include identification information indicating whether it is for the relay UE or for the remote UE. For example, when the identification information is ‘1’, the paging message may be a paging message for the remote UE, and when the identification information is ‘0’, the paging message may be a paging message for the relay UE.

ii. A UE identity (for example, S-TMSI, IMSI, or local identifier) for identifying the remote UE may be included. In this case, the UE identity may be included only when the paging message is paging for the remote UE.

4. The MME_1 transmits the paging message to the eNB_2. In this case, when the relay UE is in the EMM-IDLE mode, the MME_1 may transmit the paging message to all eNBs corresponding to the TAI list of the relay UE.

When the MME_1 recognizes the EMM state (or mode) of the relay UE, and when the relay UE is in the EMM-CONNECTED mode, it is possible to identify a cell (or eNB) in which the relay UE is camped on.

In this case, the MME_1 may transmit the paging message only to the identified cell (or eNB).

However, if the MME_1 does not recognize the EMM state (or mode) of the relay UE, or if the MME_1 recognizes the EMM state (or mode) of the relay UE, but the relay UE is in the EMM-IDLE mode, the MME_1 may transmit the paging message to all eNBs included in the TAI list allocated to the remote UE as described with reference to FIG. 11.

In this case, among the eNBs that receive the paging message from the MME 1, the eNB in which the relay UE is camped on and recognizes that the relay UE is in the EMM-CONNECTED mode may transmit the RRC message including the information on the RRC message for the remote UE and/or the paging message for the remote UE to the corresponding relay UE through the dedicated signaling.

In addition, among the eNBs receiving the paging message from the MME 1, the eNB without the information (UE context) for the relay UE performs the paging procedure described with reference to FIG. 11.

A) below describes a method for MME_1 to recognize an EMM state (or mode) of a relay UE.

A. When the MMES of the remote UE and the relay UE are different from each other, the MME_2 of the relay UE may inform the MME_1 of the EMM state (or mode) of the relay UE. In this case, the MME_1 may request the EMM state (or mode) to the MME_2.

However, when the MMES of the remote UE and the relay UE are the same, the MME_1 may recognize the EMM state (or mode) of the relay UE without a procedure for separately informing the EMM state (or mode) of the relay UE.

i. In this case, the MME_2 may inform the MME_1 of the information indicating the EMM state (or mode) through the procedure (for example, remote UE reporting procedure) for the remote UE or the relay UE to report the link status between the remote UE and the relay UE to the network.

That is, when the MME_2 receives the remote UE reporting message and the like and recognizes the linked state between the remote UE and the relay UE, the MME_2 may inform the MME_1 of the EMM state (or mode) of the relay UE.

The MME_2 may inform the MME_1 of the updated information whenever the EMM state (or mode) of the relay UE changes.

At this time, when the relay UE is in the EMM-CONNECTED mode, the MME_2 may further inform the MME_1 of the S1AP information (that is, MME UE S1AP ID and/or eNB UE S1AP ID) for the relay UE.

In addition, when the relay UE and the remote UE are not in the linked state (for example, when the established link is released), the MME_2 can no more perform an operation to inform the MME_1 of the EMM state (or mode) of the relay UE.

This operation may be initiated by the MME_1 and performed on the MME_2.

ii. Alternatively, when the MME_1 may receive the paging message of the remote UE, the MME_1 may request the MME_2 for status information indicating the EMM state (or mode) of the relay UE, and receive the response message including the status information in response thereto to recognize the EMM state (or mode) of the relay UE.

B. When the MME_1 recognizes the EMM state (mode) of the relay UE, and the relay UE is the EMM-CONNECTED, the MME_1 may identify the cell (or eNB) in which the relay UE is camped on, and transmit the S1AP message only to the identified cell (or eNB).

In this case, the S1AP message may be a paging message, a DOWNLINK NAS TRANSPORT message, or a newly defined S1AP message.

In this case, the following operation may be performed according to the type of S1AP message, and the MME_1 may transmit the corresponding S1AP message only to the identified cell (or eNB) by identifying the cell (or eNB) in which the relay UE is camped on.

i. When the S1AP message is an S1AP paging message, the S1AP paging message may be configured as A and B described in step 3.

The eNB_2 receiving the S1AP paging message from the MME_1 recognizes the relay UE through the UE paging identity included in the S1AP paging message, and if the relay UE recognizes whether the relay UE is RRC-CONNECTED, the relay UE may transmit the dedicated signaling or the dedicated RRC messages.

5. At this time, the eNB_2 may inform the relay UE whether the paging message for the remote UE is received, whether the downlink data is pending, or whether the downlink data need to be transmitted, and inform the relay UE that the paging message or the downlink data need to be transmitted to the remote UE.

The RRC message may be the existing RRC message or a newly defined RRC message.

The RRC message transmitted from the eNB_2 to the relay UE may include at least one of indication information indicating whether a paging message for the remote UE has been received and a UE identity (for example, S-TMSI, IMSI, local identifier) for identifying the remote UE.

6. At this time, if there is remote UE-specific paging information (for example, CN Domain IE), the RRC message may further include remote UE-specific paging information.

The relay UE receiving the RRC message from the eNB 2 transmits a PC5 message including identification information indicating that the paging message for the remote UE has been received by the remote UE corresponding to the UE identity.

In this case, when the remote UE-specific paging information is included in the RRC message, the PC5 message may further include the remote UE-specific paging information.

7. The remote UE receiving the PC5 message from the relay UE can perform a service request procedure.

The remote UE may transmit a service request message, an extended service request message, or a control plane service request message to the relay UE through the link formed between the remote UE and the relay UE in order to perform a service request procedure.

ii. If the S1AP message is a DOWNLINK NAS TRANSPORT message or a newly defined S1AP message, a paging message (NAS message) for the remote UE is encapsulated/piggybacked in the S1AP message.

If the MMEs of the remote UE and the relay UE are different, the MME 1 may transmit MME UE S1AP ID and eNB UE S1AP obtained in A as described above by including the MME UE S1AP ID and the eNB UE S1AP in the S1AP message so that the paging message (NAS message) for the remote UE is encapsulated/piggybacked in the S1AP message.

The paging message for the remote UE may be a newly defined NAS message, and the NAS message may include a protocol discriminator, a security header type, a paging identity, and a message identity.

In this case, a paging procedure described with reference to FIG. 11 may be performed to transmit the newly defined NAS message, or a procedure for paging a remote UE different from the procedure described with reference to FIG. 11 may be performed.

When a procedure different from that described with reference to FIG. 11 is performed, the NAS message may be a separately defined NAS message (for example, DL Notification message) instead of the paging message.

5. When the eNB 2 receives the S1AP message from the MME 1, the NAS message included in the S1AP message is encapsulated/piggybacked into an RRC message and transmitted to the relay UE.

6. The relay UE receiving the RRC message from the eNB_2 may transmit a NAS message included in the RRC message to the remote UE through the link formed between the relay UE and the remote UE.

7. The remote UE receiving the PC5 message from the relay UE can perform a service request procedure.

The remote UE may transmit a service request message, an extended service request message, or a control plane service request message to the relay UE through a link formed between the remote UE and the relay UE in order to perform a service request procedure.

iii. In another embodiment of the present invention, the methods of i) and ii) of B described above may be used interchangeably.

That is, when the paging message described in i) of B is used, the NAS message described in ii) may be encapsulated in the paging message instead of the information on the remote UE.

Alternatively, when using the S1AP message described in ii) of B, instead of the NAS message (that is, the NAS message is not included in the S1AP message), the IE indicating that the paging of the remote UE is required or the IE indicating that the downlink data for the remote UE are generated may be included in the S1AP message.

In this case, the eNB_2 receiving the S1AP message from the MME 1 may transmit dedicated signaling or dedicated RRC message to the relay UE as described in i) of B.

iv. The operation described in i) may be applied even when the MME_1 does not recognize the EMM state (or mode) of the relay UE or the MME_1 recognizes the EMM state (or mode) of the relay UE, but the relay UE is EMM-IDLE.

In this case, the MME_1 may transmit a paging message to all eNBs included in the TAI list of the remote UE. At this time, when among all the eNBs included in the TAI list, the eNB in which the relay UE is camped on recognizes that the relay UE is in the EMM-CONNECTED mode (that is, for the eNB with information on the UE or UE context), the eNB may operate as i) of B.

Among all eNBs included in the TAI list, an eNB in which a relay UE is not camped on, that is, an eNB without eNB information or UE context may perform a paging procedure described with reference to FIG. 11.

v. When the MME_1 recognizes the EMM state (mode) of the relay UE, and the relay UE is the EMM-CONNECTED, the MME_1 may identify the cell (or eNB) in which the relay UE is camped on, and transmit the S1AP message only to the identified cell (or eNB).

The S1AP message transmitted by the MME_1 may be the S1AP paging message described above in i) of B, or may be the DOWNLINK NAS TRANSPORT message described in ii) of B or a newly defined S1AP message.

In this case, the operation of each entity according to each message is also the same as the operation described above.

vi. If the MME 1 does not recognize the EMM state (or mode) of the relay UE, as described in iv) of B, the MME_1 and the eNB_2 may operate. In addition, the relay UE and the remote UE may also operate as described in i) of B.

vii. If the MME_1 does not recognize the EMM state (or mode) of the relay UE, or if the MME_1 recognizes the EMM state (or mode) of the relay UE, but the relay UE is in the EMM-IDLE mode, the MME_1 transmits the paging message to all eNBs included in the TAI list of the remote UE.

At this time, if the MME_1 knows the TAI list information of the relay UE, when the MME_1 transmits the paging message of the remote UE, the MME_1 configures a TAI list in which the TAI list of the relay UE and the TAI list of the remote UE overlap, and the may transmits the paging message only to the eNB included in the configured TAI list.

In this case, since the MME 1 transmits a paging message only to eNBs included in the TAI list of the relay UE among eNBs included in the TAI list of the remote UE, the signaling overhead may be reduced.

The method for MME_1 to recognize the TAI list of the relay UE may be the same as the method for MME_1 to recognize the EMM state (or mode) of the relay UE described in A).

viii. In addition, the method of reducing the signaling overhead of the paging message by causing the MME_1 described above to recognize additional information (for example, EMM state (or mode) or TAI list) of the relay UE may be performed through another procedure.

For example, the MME_1 forwards the paging message of the remote UE to the MME_2 that knows the information on the relay UE, thereby reducing the signaling overhead of the paging message.

5. The eNB_2 which receives the paging message from the MME 1 transmits the received paging message to the relay UE.

In this case, when the eNB_2 receives S1AP messages other than the S1AP paging message from the MME 1, the operation performed by the eNB_2 is described in step 4 above.

A. When the relay UE is in the EMM-IDLE (RRC-DILE) mode, the eNB_2 transmits the paging message to the relay UE at the paging occasion calculated by calculating the paging frame and the paging occasion based on the UE Identity Index value included in the paging message.

6. The relay UE receives the paging message from the eNB_2. When the relay UE receives other RRC messages other than the paging message, the operation performed by the relay UE is described in step 4 above.

A. When the relay UE is in the EMM-IDLE (RRC-DILE) mode, the relay UE wakes up at its own paging occasion and monitors the paging message. When the relay UE receives the paging message, the relay UE checks the IE described in B) of step 3 included in the paging message and checks whether the received paging message is a paging message for the relay UE or a paging message for the remote UE.

When the received paging message is the paging message of the remote UE, the relay UE transmits the paging message to the remote UE through the PC5 link established between the remote UEs.

7. The remote UE receiving the PC5 message from the relay UE can perform a service request procedure. When the remote UE receives other RRC messages other than the paging message, the operation performed by the remote UE is described in step 4 above.

In another embodiment of the present invention, the eNB_2 may receive the paging message transmitted from the MME and then may not immediately transmit the paging message to each UE.

For example, the eNB_2 may receive and store paging messages for different UEs transmitted from the MME, and then transmit the stored paging messages to each UE.

In this case, each transmitted paging message may include an identifier for identifying each UE.

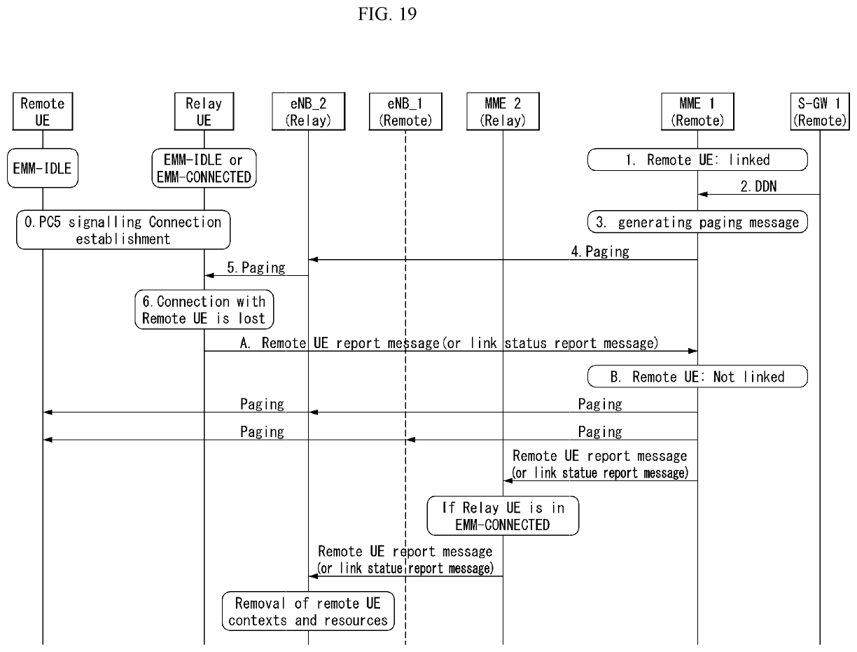

FIG. 19 is a diagram illustrating a paging procedure according to an embodiment of the present invention.

Referring to FIG. 19, when the relay UE cannot transmit the paging message to the remote UE, the relay UE may report this to the MME so that the eNB 2 may directly transmit the paging message to the remote UE.

First, since step 0 to step 5 are the same as step 0 to step 5 of FIG. 18, the description thereof will be omitted.

6. As described in step 5 or step 4 of FIG. 18, when the relay UE receives a message (paging message or other message, etc.) for paging of the remote UE from the eNB_2, the relay UE cannot communicate with the remote UE.

For example, although the PC5 link with the remote UE is released or a message for paging is transmitted to the remote UE through the established PC5 link, a response thereto may not be received from the remote UE.

A. When the relay UE recognizes that it cannot communicate with the remote UE, the relay UE transmits a NAS message (for example, remote UE report message, link status report message or the like) to inform the MME_1 that the relay UE cannot communication with the remote UE.

For example, the relay UE may transmit the NAS message to the MME_1 to inform the MME_1 that the relay UE is not linked with the remote UE or to inform the remote UE that the relay UE cannot transmit a message.

B. The MME_1 receiving the NAS message for informing the communication with the remote UE from the eNB_2 may recognize that the remote UE is not in the linked state or the communication is not possible.

i. Thereafter, the MME_1 may perform the paging procedure as described in FIG. 11 instead of the paging procedure performed in the state in which the remote UE is linked.

That is, the MME_1 may transmit the paging message to the remote UE based on the information related to the remote UE.

ii. If in step 4), the MME_1 transmits the paging message only to the cell (or eNB) in which the relay UE is camped on, the MME_1 may perform the paging procedure again. In this case, the MME_1 may retransmit the paging message to all eNBs connected to the MME_1, and the cell (or eNB) which has already transmitted the paging message may be excluded.

iii. When the relay UE is in the EMM-CONNECTED mode, the MME_1 informs at least one eNB, in which the relay UE is camped on, that the relay UE and the remote UE are no longer linked.

In this case, the MME_1 may transmit the S1AP message to inform the at least one eNB that the relay UE and the remote UE are no longer linked, and the S1AP message may identify an identity (for example, IMSI, S-TMSI, local identifier or the like) for identifying the remote UE.

At least one eNB that receives the S1AP message from the MM_1 recognizes that the link between the relay UE and the remote UE is released or the relay UE cannot communicate with the remote UE, and performs an operation of removing/deleting the relationship between the remote UE and the relay UE.

That is, at least one eNB deletes the context (for example, local identifier) of the remote UE and, if necessary, releases the DRB associated with the traffic of the remote UE.

In addition, at least one eNB_2 may delete the SLRB of the remote UE and delete the configuration in which the deleted SLRB was mapped to the DRB of the relay UE.

In another embodiment of the present invention, when the remote UE releases the PC5 connection with the relay UE, the relay UE may inform the network (ie, MME_1) whether the remote UE is in an out-of-coverage state.

That is, when the remote UE leaves the area of the eNB, the remote UE may transmit an indicator indicating that the remote UE is in the out-of-coverage state to the MME through the NAS message.

In this case, the NAS message may be a remote UE report message described with reference to FIGS. 13 to 17.

The timing when the relay UE informs the MME_1 of the out-of-coverage state of the remote UE may be the timing when the procedure (for example, a remote UE reporting procedure) for the remote UE or the relay UE to inform the network of the linked state between the two UEs or the procedure (for example, TAU procedure) for NAS signaling is performed.

In this case, the IE indicating that the remote UE is in the out-of-coverage state may be included in a message transmitted and received in each procedure.

The MME_1 that receives the IE indicating that the remote UE is in the out-of-coverage state may recognize that the remote UE is currently in a state in which communication is impossible (temporary unreachable) and perform the following operation.

Even if a DDN is received for a remote UE, the paging message is not transmitted to the eNB, and a DDN response message or a DDN failure message is transmitted to the serving S-GW (or HSS), thereby informing that the remote UE is in the out-of-coverage state or cannot communication.

Alternatively, the MME_1 may inform serving S-GW (or HSS) of the remote UE that the remote UE is in the out-of-coverage state or cannot communication before receiving the DDN.

The serving S-GW (or HSS) may recognize that the remote UE is in the out-of-coverage state or cannot communication, and may perform the paging procedure described with reference to FIG. 11.

Subsequently, when the MME_1 recognizes that the remote UE is in an in-coverage state or can communication, the MME 1 may switch the state of the remote UE to the state in which the remote UE can communication and may inform the serving S-GW (or HSS) of this state.

For example, when the remote UE enters the region of the eNB, the remote UE establishes the link with the relay UE, or when the remote UE performs a mobility management procedure, the MME_1 may transmit, to the serving S-GW (or HSS), the indication information indicating that the remote UE can communicate.

At this time, the relay UE may inform the network (that is, MME 1) whether the remote UE is in the out-of-coverage state or the in-coverage state while the link is maintained from the moment that the remote UE establishes the link with the relay UE by transmitting the indication information indicating the out-of-coverage state of the remote UE.

Names used in the methods described with reference to FIGS. 1 to 19 may be changed and used as shown in Table 24 below.

TABLE 24

| Existing Name | Changed Name |
|---|---|
| EMM-CONNECTED (RRC- | CM-CONNECTED (gNB- |
| CONNECTED) mode | CONNECTED) mode |
| eNB | gNB |
| MME | AMF (or SMF) |
| MME-EMM (layer) | AMF (5GMM-layer) |
| MME-ESM (layer) | SMF (5GMM-layer) |
| S1AP (interface/message) | N2 (interface/message) |
| NAS (signaling | N1 (connection/interface) |
| connection/interface) | |
| S-GW user plane function | UPF(lalyer) |
| P-GW user plane function | |

The term shown in Table 24 is merely an example, and each name for the term may be various.

General Apparatus to which the Present Invention can be Applied

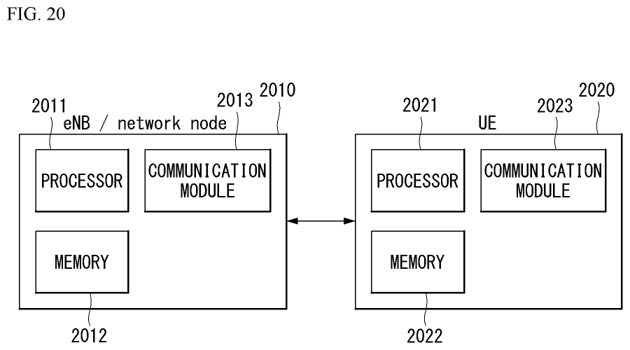

FIG. 20 is a block configuration diagram of a communication device according to an embodiment of the present invention.

Referring to FIG. 20, a wireless communication system includes a network node 2010 and a plurality of terminals (UEs) 2020.

The network node 2010 includes a processor 2011, a memory 2012, and a communication module 2013. The processor 2011 implements the functions, the processes, and/or the methods proposed in FIGS. 1 to 23. The layers of the wired/wireless interface protocol may be implemented by the processor 2011.

The memory 2012 is connected to the processor 2011 and stores various information for driving the processor 2011. The communication module 2013 is connected to the processor 2011 and transmits and/or receives a wired/wireless signal. Examples of the network node 2010 may include, a base station, an MME, an HSS, an SGW, a PGW, an SCEF, an SCS/AS, and the like. In particular, when the network node 2010 is the base station, the communication module 2013 may include a radio frequency unit (RF) for transmitting/receiving a wireless signal.

The terminal 2020 includes a processor 2021, a memory 2022, and a communication module (or RF unit) 2023. The processor 221 implements the functions, the processes, and/or the methods proposed in FIGS. 1 to 23. The layers of the radio interface protocol may be implemented by the processor 2021. In particular, the processor may include a NAS layer and an AS layer. The memory 2022 is connected to the processor 2021 and stores various information for driving the processor 2021. The RF unit 2023 is connected to the processor 2021 and transmits and/or receives a wireless signal.

The memories 2012 and 2022 may be inside or outside the processors 2011 and 2021 and may be connected to the processors 2011 and 2021 by various well-known means. Also, the network node 2010 (in the case of the base station) and/or the terminal 2020 may include a single antenna or multiple antennas.

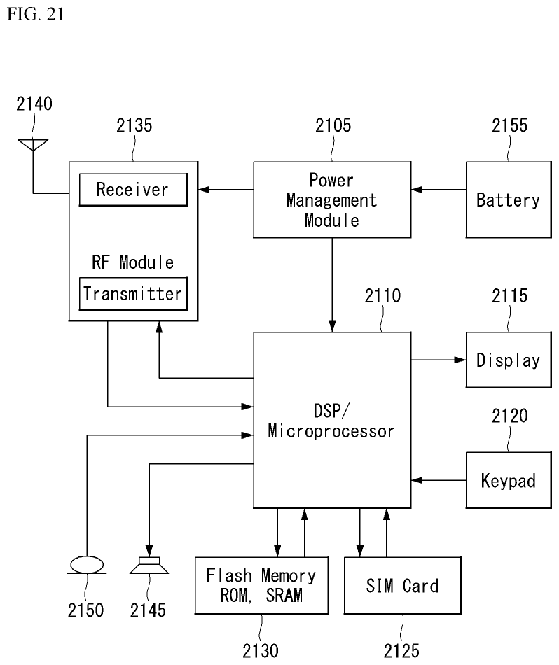

FIG. 21 is a block configuration diagram of a communication device according to an embodiment of the present invention.

In particular, FIG. 21 is a diagram illustrating the terminal of FIG. 20 in more detail.

Referring to FIG. 21, a terminal may be configured to include a processor (or a digital signal processor (DSP)) 2110, an RF module (or RF unit) 2135, and a power management module 205, an antenna 2140, s battery 2155, s display 2115, s keypad 2120, s memory 2130, a subscriber identification module (SIM) card 2125 (this configuration is optional), a speaker 2145, and a microphone 2150. The terminal may also include a single antenna or multiple antennas.

The processor 2110 implements the functions, the processes, and/or the methods proposed in FIGS. 1 to 19. The layers of the radio interface protocol may be implemented by the processor 2110.

The memory 2130 is connected to the processor 2110 and stores various information related to an operation of the processor 2110. The memory 2130 may be inside or outside the processors 2110 and 1921 and may be connected to the processors 1911 and 1921 by various well-known means.

The user inputs command information such as a telephone number, for example, by pressing (or touching) a button on the keypad 2120 or by voice activation using the microphone 2150. The processor 2110 is processed to receive the command information and perform a proper function as placing a call by a phone number. Operational data may be extracted from the SIM card 2125 or the memory 2130. In addition, the processor 2110 may display command information or driving information on the display 2115 for the user to recognize and for convenience.

The RF unit 2135 is connected to the processor 2110 and transmits and/or receives an RF signal. The processor 2110 transmits command information to the RF module 2135 to transmit, for example, a wireless signal constituting voice communication data to initiate communication. The RF module 2135 includes a receiver and a transmitter for receiving and transmitting a wireless signal. The antenna 2140 functions to transmit and receive the wireless signal. When receiving the wireless signal, the RF module 2135 may transmit a signal and convert the signal into baseband to be processed by the processor 2110. The processed signal may be converted into audible or readable information output through the speaker 2145.

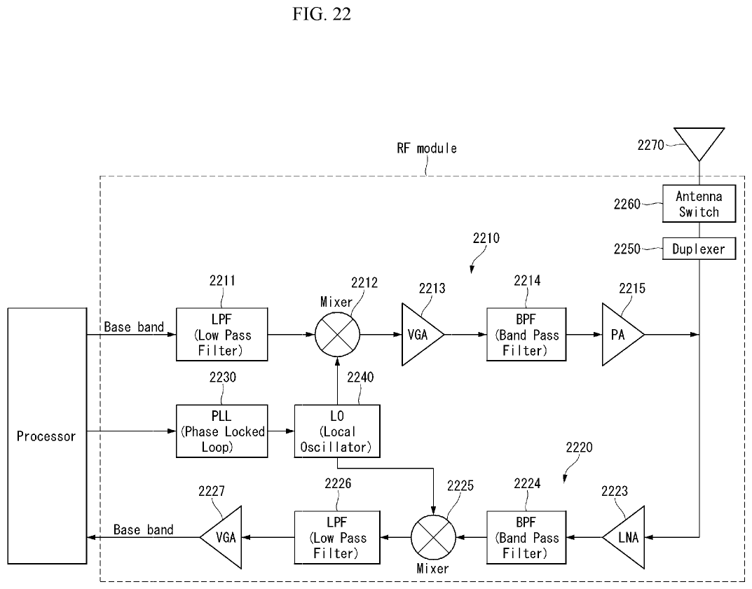

FIG. 22 is a diagram illustrating an example of an RF module of a wireless communication device to which a method proposed in this specification can be applied.

Specifically, FIG. 22 illustrates an example of an RF module that may be implemented in a frequency division duplex (FDD) system.

First, on the transmission path, the processor described in FIGS. 20 and 21 processes the data to be transmitted and provides an analog output signal to a transmitter 2210.

Within the transmitter 2210, an analog output signal is filtered by a low pass filter (LPF) 2211 to remove images caused by digital-to-analog conversion (ADC), and up-converted from a baseband into RF by an up-converter (mixer) 2212, and amplified by a variable gain amplifier (VGA) 2213, and the amplified signal is filtered by a filter 2214, additionally amplified by a power amplifier (PA) 2215, routed through a duplexer(s) 2250/antenna switch(s) 2260, and transmitted through an antenna 2270.

Also, on a receiving path, the antenna 2270 receives signals from the outside and provides the received signals, which are routed through the antenna switch(s) 2260/duplexers 2250 and transmitted to the receiver 2220.

Within the receiver 2220, the received signals are amplified by a low noise amplifier (LNA) 2223, filtered by a bandpass filter 2224, and down-converted from RF into a baseband by a down-converter (mixer) 2225.

The down-converted signal is filtered by a low pass filter (LPF) 2226 and amplified by VGA 2227 to obtain an analog input signal, which is provided to the processor described in FIGS. 20 and 21.

In addition, a local oscillator (LO) generator 2240 generates transmitting and receiving LO signals and provides the generated transmitting and receiving LO signals to the up-converter 2212 and the down converter 2225, respectively.

In addition, a phase locked loop (PLL) 2230 also receives control information from the processor to generate the transmitting and receiving LO signals at appropriate frequencies and provides control signals to an LO generator 2240.

Also, circuits shown in FIG. 22 may be arranged differently from the configuration illustrated in FIG. 22.

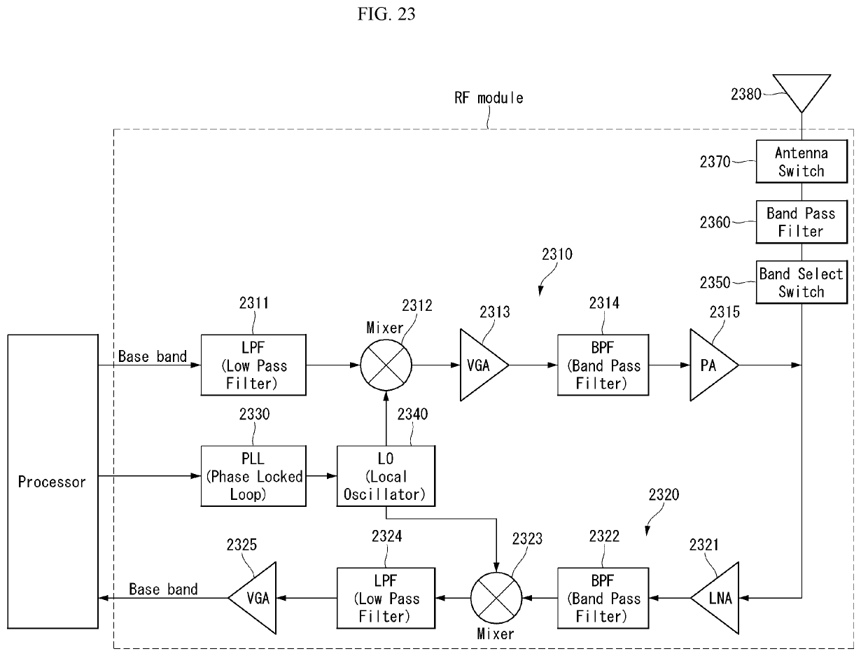

FIG. 23 is a diagram illustrating another example of an RF module of a wireless communication device to which a method proposed in this specification can be applied.

FIG. 23 is a diagram illustrating another example of an RF module of a wireless communication device to which a method proposed in this specification can be applied.

Specifically, FIG. 23 illustrates an example of an RF module that may be implemented in a time division duplex (TDD) system.

A transmitter 2310 and a receiver 2320 of the RF module in the TDD system have the same structure as the transmitter and receiver of the RF module in the FDD system.

Hereinafter, only the structure of the RF module of the TDD system that differs from the RF module of the FDD system will be described, and the description of the same structure is made with reference to FIG. 15.

The signal amplified by the power amplifier (PA) 2315 of the transmitter is routed through a band select switch (2350), a band pass filter (BPF) 2360 and an antenna switch(s) 2370 and is transmitted through the antenna 2380.

Also, on the receiving path, the antenna 2380 receives signals from the outside and provides the received signals, which are routed through the antenna switch(s) 2370, the band pass filter 2360, and the band select itch 2350 and transmitted to the receiver 2320.

In the embodiments described hereinabove, components and features of the present disclosure were combined with each other in a predetermined form. It is to be considered that the respective components or features are selective unless separately explicitly mentioned. The respective components or features may be implemented in a form in which they are not combined with other components or features. In addition, some components and/or features may be combined with each other to configure the embodiment of the present disclosure. A sequence of operations described in the embodiments of the present disclosure may be changed. Some components or features of any embodiment may be included in another embodiment or be replaced by corresponding components or features of another embodiment. It is obvious that claims that do not have an explicitly referred relationship in the claims may be combined with each other to configure an embodiment or be included in new claims by amendment after application.

Embodiments of the present disclosure may be implemented by various means, for example, hardware, firmware, software, or a combination thereof, etc. In the case in which an embodiment of the present disclosure is implemented by the hardware, it may be implemented by one or more application specific integrated circuits (ASICs), digital signal processors (DSPs), digital signal processing devices (DSPDs), programmable logic devices (PLDs), field programmable gate arrays (FPGAs), processors, controllers, microcontrollers, microprocessors, or the like.

In the case in which an embodiment of the present disclosure is implemented by the firmware or the software, it may be implemented in a form of a module, a procedure, a function, or the like, performing the functions or the operations described above. A software code may be stored in a memory and be driven by a processor. The memory may be positioned inside or outside the processor and transmit and receive data to and from the processor by various well-known means.

It is obvious to those skilled in the art that the present disclosure may be embodied in another specific form without departing from the essential feature of the present disclosure. Therefore, the above-mentioned detailed description is to be interpreted as being illustrative rather than being restrictive in all aspects. The scope of the present invention is to be determined by reasonable interpretation of the claims, and all modifications within an equivalent range of the present disclosure fall in the scope of the present disclosure.

### INDUSTRIAL APPLICABILITY

The present invention has been described with reference to the example applied to the 3GPP LTE/LTE-A system, but can be applied to various wireless communication systems, in particular, a 5 generation (5G) system in addition to the 3GPP LTE/LTE-A system.

1. A method for transmitting and receiving data between a base station and remote user equipment (remote UE) through a relay UE in a wireless communication system, the method comprising:
transmitting, by the relay UE, a report message for informing a connection state between the remote UE and the relay UE in an IDLE mode to a mobility management entity (MME) of the remote UE; and
receiving a report response message as a response to the report message from the MME.

2. The method of claim 1, wherein the report message is included in an RRC message is transmitted to the base station of the relay UE, and
wherein the RRC message includes S-TMSI of the remote UE or GUMMEI of the MME for the base station to transmit the report message to the MME.

3. The method of claim 2, further comprising:
receiving a PC5 message including the report message and the S-TMSI or the GUMMEI from the remote UE.

4. The method of claim 2, further comprising:
transmitting a request message requesting the S-TMSI or the GUMMEI to the remote UE; and
receiving a response message including the S-TMSI or the GUMMEI from the remote UE.

5. The method of claim 1, wherein the report response message includes a local identifier of the remote UE which is allocated by the base station.

6. The method of claim 1, wherein the report message further includes an identity for identifying the remote UE and an indicator indicating the connection state or context information indicating the connection state of the remote UE.

7. The method of claim 1, wherein when the connection between the remote UE and the relay UE is released, the report message further includes an indicator indicating whether a state of the relay UE is in an out-of-coverage state.

8. The method of claim 1, further comprising:
transmitting a message to inform the MME that the relay UE does not communication with the remote UE when the relay UE recognizes that the relay UE does not communication with the remote UE when receiving paging for the remote UE.

9. A relay UE for transmitting and receiving data between a base station and remote user equipment (remote UE) in a wireless communication system, the relay UE comprising:
a communication module configured to transmit and receive a wired/wireless signal; and
a processor configured to control the communication module,
wherein the relay UE transmits a report message for informing a connection state between the remote UE and the relay UE in an IDLE mode to a mobility management entity (MME) of the remote UE, and
receives a report response message as a response to the report message from the MME.
